(19) United States
(12) Patent Application Publication
(10) Pub. No.: US 2004/0111341 A1
(43) Pub. Date: Jun. 10, 2004

(54) Electronic data transaction method and electronic data transaction system

(76) Inventors: Hideki Aikoh, Higashiosaka (JP); Tomoaki Izumi, Neyagawa (JP); Tohru Nakamura, Osaka (JP)

Correspondence Address: SNELL & WILMER, ONE ARIZONA CENTER, 400 EAST VAN BUREN, PHOENIX, AZ, 850040001

(21) Appl. No.: 10/380,367

(22) PCT Filed: Sep. 28, 2001
(86) PCT No.: PCT/JP01/08608

(30) Foreign Application Priority Data
Oct. 31, 2000 (JP) 2000-334024

(51) Int. Cl. G06F 17/60

(52) U.S. Cl. 705/35

(57) ABSTRACT

An electronic data transaction system for onerously transferring copyright-protected electronic data (intangible form) without allowing the user to duplicate the data. The system resells the received electronic data to another consumer at a price lower than the regular price. This reselling system heightens the market awareness of consumers, provides return for the copyright owners from two sources, helps build a business model based on the market competition mechanism, and contributes to reduction of the price of electronic data and to expansion of the electronic data trading market (FIG. 1).

### TECHNICAL FIELD

The present invention relates to an electronic data transaction method for conducting transactions of a variety of types of copyright-protected electronic data, such as music content, and an electronic data transaction system for use with such a method.

### BACKGROUND ART

The present day is referred to as the age of the digital network. In the age of the digital network, the consumer can purchase various forms of copyright-protected electronic data which can be generally classified into the following two forms.

Electronic data in the first form is tangible. A DVD (digital video disc) ROM (read-only memory) is one of representative examples of tangible electronic data. In this case, the consumer purchases computer software or AV data in the form of a reproduction only optical disc (the ROM form).

Electronic data in the second form is intangible. In this case, the consumer purchases electronic data distributed through a network or by a satellite or the like, rather than distributed in the form of an optical disc (the ROM form), by transferring the electronic data itself to an optical recording disc, hard disc, or semiconductor memory, which is owned by the consumer, via a business-purpose distribution terminal apparatus or an electronic distribution terminal apparatus (e.g., a personal computer of the consumer).

Regarding the second form, among various cases of combinations, a first conventional example where business-purpose distribution terminal apparatuses are used and the second conventional example where EMD (Electronic Media Distribution) is realized using electronic distribution terminal apparatuses (personal computers of the consumers) are described below with reference to drawings.

FIG. 18 is a diagram schematically illustrating a structure of an electronic data transaction system 5 according to the first conventional example where the business-purpose distribution terminal apparatuses are used. In FIG. 18, the operator operates an electronic data transaction system including an input/output dedicated system 6 in which a plurality of business-purpose distribution terminal apparatuses 61 are connected together via optical fibers to form a network.

A business-purpose distribution terminal apparatus 61 performs record processing of desired electronic data, such as music content, on a MiniDisc (hereinafter, referred to as the “MD”) which is a recording medium loaded into the business-purpose distribution terminal apparatus 61 by the purchaser. This allows the purchaser to transfer-purchase electronic data from the operator side.

A specific operation of the electronic data transaction system 5 will be described in further detail below.

The electronic data transaction system 5 distributes electronic data, such as music content, to an MD (MiniDisc) of the purchaser in an “on-demand” manner, which meets the needs of the consumer, and ATM (asynchronous transfer mode) service is provided through a network using optical fibers.

The operator constructs the input/output dedicated system 6 as the electronic data transaction system 5 by means of the network using optical fibers. The input/output dedicated system 6 holds a plurality (several tens to several tens of thousands) of dedicated business-purpose distribution terminal apparatuses 61 which are installed in, for example, convenience stores.

A purchaser (consumer) who wants to purchase electronic data, such as music content, brings his/her own MD to a convenience store in which a dedicated business-purpose distribution terminal apparatus 61 is installed and loads that MD into the dedicated business-purpose distribution terminal apparatus 61.

The purchaser searches music content that he/she desires using the business-purpose distribution terminal apparatus 61 and puts a prescribed amount of purchase money therein for each piece of music, thereby transfer-purchasing electronic data for the desired music content from the business-purpose distribution terminal apparatus 61 to the purchaser's MD. In this case, since the input/output dedicated system 6 includes the network using optical fibers, the electronic data is transmitted from the input/output dedicated system 6 to the business-purpose distribution terminal apparatus 61 at, for example, 3 M bits/sec. and the music content is recorded to the purchaser's MD via the business-purpose distribution terminal apparatus 61. This allows the purchaser to bring the desired music content recorded on the MD as his/her purchase and to enjoy the sound of the desired music content output by his/her own MD player or the like.

Although the purchase money paid by the purchaser through the dedicated business-purpose distribution terminal apparatus 61 goes to the operator, the operator returns portions of the purchase money to, for example, the installer of the distribution terminal apparatus in the convenience store and the copyright owner of the music content who is also the provider of the music content.

FIG. 19 is a diagram schematically illustrating a structure of an electronic data transaction system according to the second conventional example where EMD (Electronic Media Distribution) is realized using electronic distribution terminal apparatuses (personal computers of the consumers). In FIG. 19, the operator operates an electronic data transaction system 7 including an input/output dedicated system 8 networked via the Internet, and personal computers which are user terminal apparatuses 9 (hereinafter, simply referred to as the “personal computers”), so as to transfer-purchase electronic data, such as music content, via the network.

A specific operation of the electronic data transaction system 7 will be described in further detail below.

In the electronic data transaction system 7, the network constructed by using internet connections allows the purchaser who is a consumer to download electronic data, such as music content, to his/her personal computer 9 at the demand of the consumer.

The operator constructs the electronic data transaction system 7 by associating the input/output dedicated system 8 with the personal computers 9 of the purchasers through the network constructed by using internet connections. Accordingly, the input/output dedicated system 8 is connected to countless purchasers' personal computers 9 and other various computers.

A purchaser who wants to purchase electronic data, such as music content, connects his/her personal computer 9 to the Internet (network) to demand music content that he/she wants from the input/output dedicated system 8. In response to that demand, mutual authentication between a music distribution server (not shown) in the input/output dedicated system 8 and the personal computer 9 is performed. If the authentication is correctly performed, the music distribution server (not shown) in the input/output dedicated system 8 enciphers the music content stored therein and distributes the enciphered music content to the personal computer 9 of the purchaser. The music content transfer-purchased through the distribution is stored in a hard disc (not shown) of the personal computer 9, and the purchaser can decipher and reproduce the stored music content using the personal computer 9. The purchaser pays a prescribed amount of purchase money for each piece of music. The purchaser can enjoy the desired music content as his/her purchase using his/her personal computer 9 or portable terminal apparatus. Although the purchase money paid by the purchaser through the input/output dedicated system 8 goes to the operator, the operator returns a portion of the purchase money to the copyright owner of the music content who is also the provider of the music content.

The above-described electronic data transaction systems 5 and 7 in the second form provide the purchaser with a large number of advantages. The major advantage among them is that music content, which is electronic data, can be directly transfer-purchased in the form of electronic data, rather than in the form of a hard package such as a reproduction-only optical disc (the ROM form).

On the other hand, in the case of the above-described first form, electronic data (music content) is in the tangible form, such as a CD-ROM, and therefore a secondhand selling system is available. In fact, there is a business model in which a CD-ROM purchased by the purchaser is onerously delivered over to a secondhand selling system trader and the secondhand selling system trader sells the CD-ROM at second hand as a so-called used article.

However, in the above-described electronic data transaction system 5 or 7, the purchaser, who is a consumer, purchases music content from the legitimate route through the input/output dedicated system 6 or 8, and there are no secondhand selling systems for selling the music content at second hand as electronic data when the purchased music content is not necessary.

In the case of the above-described first form, in addition to a choice to purchase new music content as a CD-ROM at the regular price, the purchaser can have a choice to purchase aged music content at a price lower than the regular price through the secondhand selling system. Based on the market awareness, from the viewpoint of the consumers who are the purchasers, that the purchase price of aged electronic data, such as music content, is required to be low, this business model creates a certain scale of market. It is obvious that the form of purchasing copyright-protected electronic data, such as music content, would be shifted to the second form, rather than the first form, in the future as the age of the digital network further advances.

However, no secondhand selling system, which is formed as a business based on the market awareness of the consumers (purchasers), is available in the second form, while the shift to the second form is accelerated, and therefore there is a problem in that the spread of electronic data transaction, i.e., the expansion of market in the second form, is prevented.

The present invention solves the above-described problems, and objectives thereof are to provide: an electronic data transaction method as a new business model capable of further promoting the spread of electronic data transaction; a program for allowing a computer to execute the electronic data transaction method; and an electronic data transaction system for use with such a program.

### DISCLOSURE OF THE INVENTION

In an electronic data transaction method according to the present invention, electronic data transaction is performed using an operator-side input/output dedicated system in which a plurality of dedicated terminal apparatuses capable of inputting/outputting copyright-protected electronic data thereto/therefrom are networked, the first electronic data is transfer-sold to the input/output dedicated system via a dedicated terminal apparatus without allowing the first electronic data to be duplicated and a portion of the first alternative value involved in the data transfer-selling is paid from the operator to the seller, thereby achieving the above objectives. Alternatively, in an electronic data transaction method according to the present invention, electronic data transaction is performed using an operator-side input/output dedicated system connected via a network to a plurality of user terminal apparatuses capable of inputting/outputting copyright-protected electronic data thereto/therefrom, the first electronic data is transfer-sold to the input/output dedicated system via a user terminal apparatus without allowing the first electronic data to be duplicated and a portion of the first alternative value involved in the data transfer-selling is paid from the operator to the seller, thereby achieving the above objectives. In an electronic data transaction method according to claim 1 or 4, the data transfer-selling is at least either data transfer-reselling or data transfer-selling of electronic data on which electronic data transaction has never been performed.

Alternatively, in an electronic data transaction method according to the present invention, electronic data transaction is performed using an operator-side input/output dedicated system in which a plurality of dedicated terminal apparatuses capable of inputting/outputting copyright-protected electronic data thereto/therefrom are networked, the first electronic data is transfer-sold to the input/output dedicated system via/from a dedicated terminal apparatus without allowing the first electronic data to be duplicated, a portion of the first alternative value involved in the data transfer-selling is paid from the operator to the seller, the first electronic data is transfer-purchased from the input/output dedicated system via/to the dedicated terminal apparatus without leaving a duplicate of the first electronic data, and the second alternative value involved in the data transfer-purchasing is paid from the purchaser to the operator, thereby achieving the above objectives. Alternatively, in an electronic data transaction method according to the present invention, electronic data transaction is performed using an operator-side input/output dedicated system connected via a network to a plurality of user terminal apparatuses capable of inputting/outputting copyright-protected electronic data thereto/therefrom, the first electronic data is transfer-sold to the input/output dedicated system via/from a user terminal apparatus without allowing the first electronic data to be duplicated and a portion of the first alternative value involved in the data transfer-selling is paid from the operator to the seller, the first electronic data is transfer-purchased from the input/output dedicated system via/to the user terminal apparatus without leaving a duplicate of the first electronic data, and the second alternative value involved in the data transfer-purchasing is paid from the purchaser to the operator, thereby achieving the above objectives.

Further, in an electronic data transaction method according to claim 2, it is preferred that the second electronic data on which electronic data transaction has never been performed is transfer-purchased via the dedicated terminal apparatus without leaving a duplicate of the second electronic data and the third alternative value involved in the data transfer-purchasing is paid from the purchaser to the operator. Furthermore, in an electronic data transaction method according to claim 5, it is preferred that the second electronic data on which electronic data transaction has never been performed is transfer-purchased via the user terminal apparatus without leaving a duplicate of the second electronic data and the third alternative value involved in the data transfer-purchasing is paid from the purchaser to the operator.

Further still, in an electronic data transaction method according to claim 1 or 4, it is preferred that the electronic data can be transferred to an exclusive prescribed recording medium without allowing the electronic data to be duplicated, and the recording medium is loaded into the dedicated terminal apparatus or the user terminal apparatus so as to allow the electronic data to be transfer-sold from the recording medium to the input/output dedicated system via the dedicated terminal apparatus or the user terminal apparatus and so as to allow the electronic data to be transfer-purchased from the input/output dedicated system to the recording medium via the dedicated terminal apparatus or the user terminal apparatus without leaving a duplicate of the electronic data.

Further still, in an electronic data transaction method according to claim 3 or 6, it is preferred that a portion of at least any one of the first through third alternative values is paid from the operator to the copyright owner of the electronic data.

Further still, in an electronic data transaction method according to claim 3 or 6, it is preferred that by configuring a terminal apparatus in the input/output dedicated system so as to display at least any one of a listing of the first alternative value for the first electronic data, a listing of the second alternative value for the first electronic data, and a listing of the third alternative value for the second electronic data.

Further still, in an electronic data transaction method according to claim 3 or 6, it is preferred that information regarding the number of times of at least transfer-selling of electronic data selected from the group consisting of the transfer-selling of electronic data and transfer-purchasing of electronic data is recorded in a prescribed storage section, evaluation information about the electronic data based on input from the seller is recorded in the prescribed storage section when the electronic data is transfer-sold, and an electronic data evaluation aggregate screen based on the number-of-times information the evaluation information is displayed when the electronic data is transfer-purchased.

Further still, in an electronic data transaction method according to claim 3 or 6, it is preferred that at least any one of the first alternative value, the second alternative value, and the third alternative value corresponds to a charge settling amount.

In a program according to the present invention, an electronic data sell-transferring step for allowing a computer to execute a data transfer operation for transferring desired copyright-protected electronic data via a terminal apparatus from the seller's memory means to an input/output dedicated system connected to the terminal apparatus via a network is recorded in a readable recording medium, thereby achieving the above objectives.

Further, in a program according to claim 13, it is preferred that a charge settling step for allowing a computer to execute an operation for processing charge settlement in accordance with electronic data transfer-sell processing and with reference to a prescribed charge table is recorded in the readable recording medium.

An electronic data transaction system according to the present invention performs transaction of copyright-protected electronic data and includes: electronic data transfer-purchase processing means for performing electronic data transfer-purchase processing via a terminal apparatus so as to transfer-purchase desired electronic data from an operator-side storage section to a purchaser-side storage section via a network; and electronic data transfer-sell processing means for performing electronic data transfer-sell processing via the terminal apparatus so as to transfer-sell electronic data desired to be sold from a seller-side storage section to the operator-side storage section via the network, thereby achieving the above objectives.

Further, it is preferred that an electronic data transaction system according to claim 15 includes charge settling means for performing charge settle processing so as to settle charges responsive to the electronic data transfer-purchase processing and the electronic data transfer-sell processing.

Functions of the above structure will be described below.

In the case where copyright-protected electronic data is distributed from an input/output dedicated system via a network, when the holder who obtained the electronic data at the regular price through the legitimate route for purchasing determines that such electronic data is not necessary, the holder can sell the electronic data onerously (or free of charge) by transferring the electronic data desired to be sold to the input/output dedicated system via a dedicated terminal apparatus installed in, for example, a convenience store or via an exclusive prescribed user terminal apparatus, such as a personal computer. In addition to the data transfer-reselling, transfer-selling of electronic data on which electronic data transaction has never been performed is possible as a method of transfer-selling data. In the case where transfer-selling of electronic data on which electronic data transaction has never been performed is possible, for example, consumers' eagerness for creation is further intensified, whereby the spread of the electronic data transaction can be further accelerated.

In the case where copyright-protected electronic data is distributed via a network, when the holder who is a consumer and obtained the electronic data at the regular price through the legitimate route for purchasing determines that such electronic data is not necessary, the holder can onerously deliver over the electronic data by transferring the electronic data desired to be sold to an input/output dedicated system via a dedicated terminal apparatus installed in, for example, a convenience store or via an exclusive prescribed user terminal apparatus, such as a personal computer. The operator who manages the input/output dedicated system uses the same input/output dedicated system to build a secondhand selling system for selling the electronic data, which is onerously delivered over, at second hand to another consumer at a price lower than the regular price. By adding such a secondhand selling system to the selling system, it is possible to further accelerate the spread of the electronic data transaction. Accordingly, based on the market awareness that the purchase price for aged electronic data used for a certain period of time is required to be low, a method for performing electronic data transaction is built as a new business model which expands the electronic data transaction market. Also, in this case, in addition to the data transfer-reselling, transfer-selling of electronic data on which electronic data transaction has never been performed is possible as a method of transfer selling data. In such a case where transfer-selling of electronic data on which electronic data transaction has ever been performed is possible, for example, consumers' eagerness for creation is further intensified, whereby the spread of the electronic data transaction can be further accelerated.

The operator manages the input/output dedicated system as a prescribed route for purchasing the second electronic data, which is directly obtained from the copyright owner and on which electronic data transaction has never been performed, whereby the purchaser can transfer-purchase the second electronic data from the input/output dedicated system via the dedicated terminal apparatus or the exclusive prescribed user terminal apparatus without leaving a duplicate of the second electronic data and the operator can receive from the purchaser the third alternative value involved in the transfer-purchasing of the electronic data. This allows the electronic data transaction not only to resell electronic data or sell electronic data at second hand but also to function as the prescribed legitimate route for purchasing.

Electronic data is recorded in an exclusive prescribed recording medium without allowing the holder to have a duplicate of the electronic data and the holder loads the recording medium into a dedicated terminal apparatus or a user terminal apparatus so as to transfer-resell electronic data to the input/output dedicated system. Further, the purchaser loads an exclusive prescribed recording medium into a dedicated terminal apparatus or a user terminal apparatus so as to transfer-purchase electronic data from the input/output dedicated system without leaving a duplicate of the electronic data. Furthermore, the electronic data is recorded to the exclusive prescribed recording medium, and therefore a consumer who is the holder or the purchaser is not required to have a user terminal apparatus and can easily provide and receive electronic data by simply going to a place where the dedicated terminal apparatus is installed.

A portion of at least one of alternative values generated by transferring of electronic data is provided to the copyright owner of the electronic data, and therefore it is possible to build a business model where a portion of an alternative value is returned to the copyright owner each time electronic data is transferred. This allows not only the acceleration of reselling and secondhand selling of electronic data but also an increase of returns to the copyright owner of electronic data as the frequency of secondhand selling of the electronic data is increased and the market value is increased. Accordingly, a business model based on the market competition mechanism can be built, returns to the copyright owner when electronic data is initially purchased through the legitimate route can be small as compared to the case where the electronic data is provided in the tangible form (e.g., in the form of a reproduction-only optical disc (the ROM form)). From the viewpoint of consumers (purchasers), it is possible to obtain an electronic data transaction method which possibly reduces the price of electronic data.

A display function is provided for displaying at least one of listings of alternative values for each piece of electronic data, and therefore a consumer who is the holder or the purchaser can consentingly conduct electronic data transaction by using the display function in order to refer to the listings of alternative values for electronic data.

Information regarding the number of times of transfer-selling and electronic data evaluation information based on inputs from a seller are recorded when electronic data is transfer-sold and an electronic data evaluation screen based on the number-of-times information and the evaluation information is displayed when the electronic data is transfer-purchased. Therefore, when transfer-purchasing the electronic data, the purchaser can refer to the evaluation screen so as to be ensured to obtain popular electronic data, thereby greatly accelerating the spread of the electronic data transaction.

Further, the amount of copyright fee of electronic data which is paid into the copyright owner's account depends on the number of times of purchasing which is the number-of-times information regarding data transfer-purchasing. Accordingly, as the number of pieces of electronic data to be put on the market is increased, the copyright fee paid to the copyright owner is increased and the initial copyright fee paid to the copyright owner can be reduced, so that the purchase price for the electronic data is reduced correspondingly. This is advantageous to general users (purchasers) and introduces the market mechanism that sales of electronic data are further increased. When a specific type of electronic data sells well, the aggregated amount of copyright fee is increased depending on the number of times of reselling and purchasing of the specific type of electronic data. Therefore, copyright owners intend to create electronic data that sells well. This achieves an effect of greatly accelerating the spread of the electronic data transaction.

Values for all kinds of electronic data to be commercially transacted can be directly determined or processed in terms of currency.

An electronic data transaction system according to the present invention can be used with the above-described electronic data transaction method of the present invention in the most suitable manner, thereby greatly accelerating the spread of the electronic data transaction.

### BRIEF DESCRIPTION OF THE DRAWINGS

FIG. 1 is a diagram illustrating an exemplary structure of an electronic data transaction system according to Embodiment 1 of the present invention.

FIG. 2 is a diagram schematically illustrating an operation status of the electronic data transaction system of FIG. 1.

FIG. 3 is a flowchart illustrating (part of) the operation of the electronic data transaction system of FIG. 1.

FIG. 4 is a flowchart illustrating (another part of) the operation of the electronic data transaction system of FIG. 1.

FIG. 5 is a diagram illustrating a structure of an exemplary electronic data transaction system according to Embodiment 2 of the present invention.

FIG. 6 is a diagram schematically illustrating an operation status of the electronic data transaction system of FIG. 5.

FIG. 7 is a flowchart illustrating the operation of the electronic data transaction system of FIG. 5.

FIG. 8 is a diagram illustrating a display screen of the dedicated terminal apparatus shown in FIG. 1 or the personal computer shown in FIG. 5 when connected to an input/output dedicated system according to Embodiment 3 of the present invention.

FIG. 9 is a diagram schematically illustrating an operation status of an electronic data transaction system according to Embodiment 4 of the present invention.

FIG. 10 is a diagram illustrating a structure of an exemplary electronic data transaction system according to Embodiment 5 of the present invention.

FIG. 11 is a diagram illustrating a structure of another exemplary electronic data transaction system according to Embodiment 5 of the present invention.

FIG. 12 is a diagram illustrating an evaluation selection screen of an electronic data transaction system according to Embodiment 6 of the present invention.

FIG. 13 is a diagram of a display screen illustrating an exemplary evaluation aggregate screen of the electronic data transaction system according to Embodiment 6 of the present invention.

FIG. 14 is a diagram of a display screen illustrating another exemplary evaluation aggregate screen of an electronic data transaction system according to Embodiment 6 of the present invention in which a personal computer is employed.

FIG. 15 is a diagram of a display screen illustrating still another exemplary evaluation aggregate screen of an electronic data transaction system according to Embodiment 6 of the present invention in which the screen is of a touch panel-type.

FIG. 16 is a diagram of a display screen illustrating still another exemplary evaluation aggregate screen of an electronic data transaction system according to Embodiment 6 of the present invention in which a personal computer is employed.

FIG. 17 is a diagram illustrating an aggregate screen of the electronic data transaction system of FIG. 16 according to Embodiment 6 of the present invention.

FIG. 18 is a diagram schematically illustrating a structure of an electronic data transaction system according to the first conventional example where business-purpose distribution terminal apparatuses are used.

FIG. 19 is a diagram schematically illustrating a structure of an electronic data transaction system according to the second conventional example where EMD is realized using electronic distribution terminal apparatuses.

### BEST MODE FOR CARRYING OUT THE INVENTION

Hereinafter, Embodiments 1-6 of the present invention will be described with reference to the drawings.

(Embodiment 1)

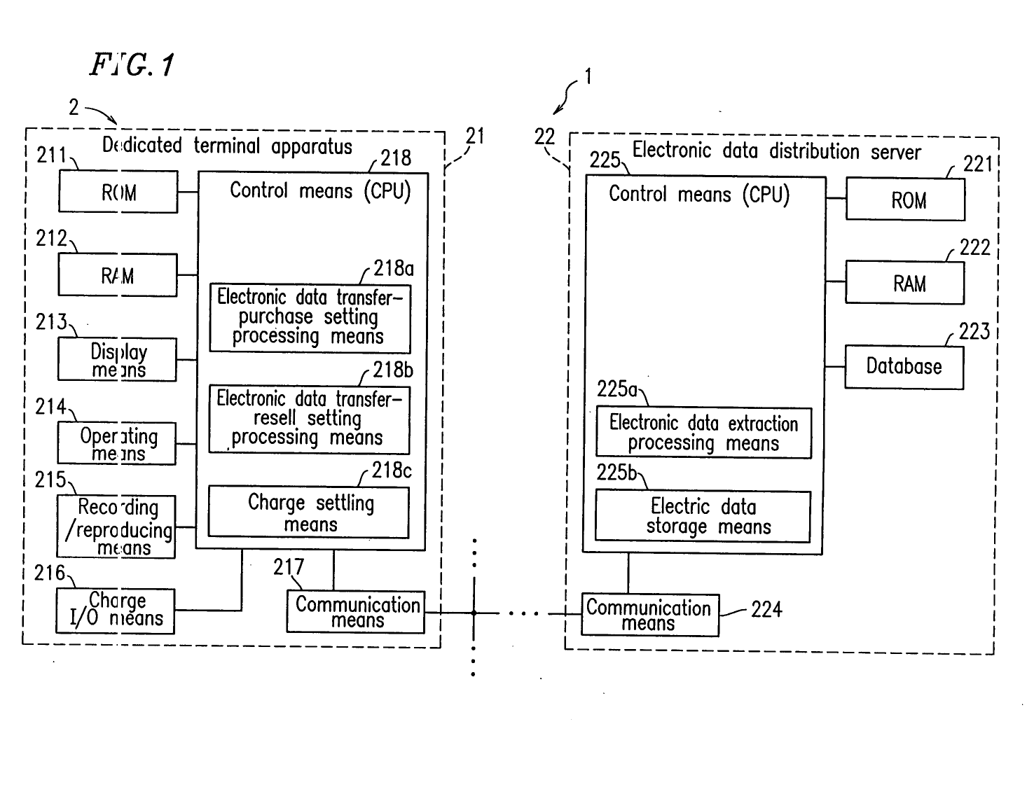

FIG. 1 is a diagram illustrating an exemplary structure of an electronic data transaction system according to Embodiment 1 of the present invention. In FIG. 1, the operator operates an electronic data transaction system 1 including an input/output dedicated system 2 networked using signal lines such as optical fibers. The input/output dedicated system 2 is constructed using a plurality (several tens to tens of thousands) of dedicated terminal apparatuses 21 installed in, for example, convenience stores and an electronic data distribution server 22 having a database in which a variety of types of copyright-protected electronic data such as music content. The dedicated terminal apparatuses 21 and the electronic data distribution server 22 can mutually exchange data via a network using optical fibers or the like.

A dedicated terminal apparatus 21 includes a ROM 211, a RAM 212, display means 213, operating means 214, recording/reproducing means 215, charge input/output means 216, communication means 217, and control means 218 for controlling these components.

The ROM 211 is read-only data storage means (readable recording medium) which stores control programs and a variety of types of data, e.g., data associated with the control programs, display screen data, etc. Such programs and data will be described later.

The RAM 212 is a work memory for temporarily storing the control programs and the variety of types of data, e.g., the data associated with the control programs, while the dedicated terminal apparatus 21 is in operation.

The display means 213 includes a liquid crystal or CRT display apparatus for displaying a variety of types of display screen data.

The operating means 214 includes key switches or a touch panel for outputting a variety of types of desired instructions, e.g., an operating instruction and a select instruction.

The data recording/reproducing means 215 records/reproduces electronic data to/from a semiconductor memory M as a storage medium prepared by the user.

The charge input/output means 216 is configured so as to detect the total value of a coin(s) inserted from a coin insert slot and/or a bill(s) inserted from a bill acceptor and return to a change return the remaining money having a value corresponding to the balance between the total value and the value of the purchase money for electronic data or the resale money (payment) for electronic data.

The communication means 217 is configured such that data can be exchanged between the business-purpose dedicated terminal apparatus 21 and the electronic data distribution server 22 by mutual communication via optical fibers.

The control means 218 includes a CPU (central processing unit) which includes: electronic data transfer-purchase setting processing means 218a for performing, based on a terminal-side control program stored in the ROM 211, electronic data transfer-purchase setting processing for transfer-purchasing desired copyright-protected electronic data, such as music content, from the dedicated terminal apparatus 21 to the purchaser's semiconductor memory M; electronic data transfer-resell setting processing means 218b as electronic data transfer-sell setting processing means for performing electronic data transfer-resell setting processing so as to sell electronic data by transferring copyright-protected electronic data, such as music content, from the purchaser's semiconductor memory M to the dedicated terminal apparatus 21; and charge settling means 218c for performing charge settling processing for settling the charge in response to the electronic data transfer-purchase processing or the electronic data transfer-resell processing.

As will be described in detail below, the terminal-side control program includes an electronic data transfer-purchase setting control program, an electronic data transfer-resell setting control program, and a charge settling control program.

When the purchaser's semiconductor memory M is set in a prescribed position within the data recording/reproducing means 215 and the charge input/output means 216 detects the amount of money equal to or greater than that required for transfer-purchasing electronic data, the electronic data transfer-purchase setting processing means 218a transmits, based on the electronic data transfer-purchase setting control program, a purchase instruction to purchase desired music content and a select instruction to select desired music content, which are input via key switches or a touch panel of the operating means 214, to the electronic data distribution server 22 via the communication means 217. Moreover, the electronic data transfer-purchase setting processing means 218a performs data transfer-purchasing based on the electronic data transfer-purchase setting control program by controlling the communication means 217 so as to receive electronic data for the desired music content transmitted by the electronic data distribution server and the data recording/reproducing means 215 so as to record the received electronic data for the desired music content to the purchaser's semiconductor memory M.

The electronic data transfer-purchase setting control program includes the step for allowing a computer (CPU 218) to execute an electronic data transfer-purchase operation for transferring desired copyright-protected electronic data, such as music content, from a terminal apparatus, i.e., the dedicated terminal apparatus 2, to the purchaser's semiconductor memory M (memory means). The electronic data transfer-purchase step includes an electronic data purchase information input processing step and a purchased electronic data output processing step.

The electronic data purchase information input processing step includes the following sequentially-executed steps: a set detection step for determining whether or not the purchaser's semiconductor memory M has been set in a prescribed position within the data recording/reproducing means 215; a purchase instruction step for determining whether or not a purchase instruction to purchase desired music content has been input via the key switches or the touch panel of the operating means 214; a select instruction step for determining whether or not a select instruction to select the desired music content has been input via the key switches or the touch panel of the operating means 214: a charge detection step for determining whether or not the charge input/output means 216 has detected the amount of money equal to or greater than that required for electronic data transfer-purchasing; and a purchase information transmitting step for transmitting the instructions to purchase and select the desired music content to the electronic data distribution server 22 via the communication means 217 after the semiconductor memory M is set, the instructions to purchase and select the desired music content are given, and the amount of money equal to or greater than that required is detected.

The purchased electronic data output processing step includes the following sequentially-executed steps: an electronic data receiving step for receiving electronic data for the desired music content transmitted by the electronic data distribution server 22 at the communication means 217; and an electronic data recording step for recording the received electronic data for the desired music content to the purchaser's semiconductor memory M using the data recording/reproducing means 215.

When the purchaser's semiconductor memory M set in a prescribed position within the data recording/reproducing means 215, the electronic data transfer-resell setting processing means 218b performs transfer-reselling of music content desired to be sold based on the electronic data transfer-resell setting control program by controlling the data recording/reproducing means 215 so as to search and extract (read) the music content desired to be sold from the purchaser's semiconductor memory M according to an electronic data resell instruction to sell electronic data, such as music content, in the semiconductor memory and an electronic data select instruction to select music content desired to be sold, which are input via the key switches or the touch panel of the operating means 214, and by transmitting the extracted electronic data to the electronic data distribution server 22 via the communication means 217.

The electronic data transfer-resell setting control program includes the step for allowing the computer (CPU 218) to execute an electronic data resell-transfer operation for transferring copyright-protected electronic data, such as music content, from the purchaser's semiconductor memory M (memory means) through a terminal apparatus, i.e., the dedicated terminal apparatus 21 to an input/output dedicated system (the electronic data distribution server 22).

The electronic data resell-transfer step includes the following sequentially-executed steps: a set detection step for determining whether or not the purchaser's semiconductor memory M has been set in a prescribed position within the data recording/reproducing means 215; a resell instruction step for determining whether or not an electronic data resell instruction to sell electronic data, such as music content, stored in the semiconductor memory has been input via the key switches or the touch panel of the operating means 214; a select instruction step for determining whether or not a select instruction to select the electronic data for music content desired to be sold has been input; an electronic data transfer-read step for using the data recording/reproducing means 215 so as to search and extract (read) the music content desired to be sold from the reseller's, i.e., seller's, semiconductor memory M; and a resell information transmitting step for transmitting the extracted electronic data to the electronic data distribution server 22 via the communication means 217.

The charge settling means 218c is controlled based on the charge settling program so as to extract and determine the amount of purchase money for purchased electronic data or the amount of resale money for sold electronic data from a table, which is stored in the ROM 211 and associated with new and old versions of the purchased or sold electronic data. The amount of purchase money is deducted from the total sum of paid money detected by the charge input/output means 216. Alternatively, the amount of resale money is added to the balance detected by the charge input/output means 216. The calculated amount of money is returned from the change return of the charge input/output means 216.

The charge settling control program includes a charge settlement step for allowing the computer (CPU 218) to execute a charge settling operation with reference to a prescribed charge table according to electronic data transfer-purchase processing or electronic data transfer-resell processing.

The charge settlement step includes the following steps sequentially executed when a purchase instruction is given: a purchase money extraction step for extracting and determining the amount of purchase money for electronic data selected for purchasing from the charge table, which is stored in the ROM 211 and associated with new and old versions of the selected electronic data; a calculation step for deducting the amount extracted from the total sum of paid money detected by the charge input/output means 216; and a change returning step for controlling the charge input/output means 216 so as to return the remainder of the money after the deduction from the change return thereof. In the case where the charge settling step includes a money information transmitting step for transmitting the amount extracted (the amount of purchase money) to the electronic data distribution server 22 via the communication means 217, the electronic data distribution server 22 can also manage the amount of money that is paid and/or returned.

Further, the charge settling step includes the following steps sequentially executed when a resell instruction is given: a resale money extraction step for extracting and determining the amount of resale money for sold electronic data from the charge table, which is stored in the ROM 211 and associated with new and old versions of the sold electronic data; a calculation step for adding the amount of resale money to the balance detected by the charge input/output means 216 when the amount extracted corresponds to the amount of resale money; and a money returning step for controlling the charge input/output means 216 so as to return the sum of money after the addition from the change return thereof. In the case where the charge settling step includes a money information transmitting step for transmitting the amount extracted (the amount of resale money) to the electronic data distribution server 22 via the communication means 217, the electronic data distribution server 22 can also manage the amount of money that is paid and/or returned.

The electronic data distribution server 22 includes: a ROM 221 as read-only data storage means; a RAM 222 as a work memory (temporary data storage means); a database 223 in which a variety of types of copyright-protected electronic data, such as music content, are registered; communication means 224 for exchanging data between the dedicated terminal apparatuses 21 and the electronic data distribution server 22; and control means 225 for controlling these components.

The control means 225 includes a CPU (central processing unit) which includes: an electronic data extraction processing means 225a for extracting electronic data desired to purchase from the database 223 based on a server-side control program stored in the ROM 221; and an electronic data storage means 225b for storing sold electronic data in the database 223.

As will be described in detail below, the server-side control program includes an electronic data extraction control program and an electronic data storage control program.

The electronic data extraction processing means 225a controls, based on the electronic data extraction control program, the communication means 224 so as to receive an electronic data purchase instruction and an electronic data select instruction from the dedicated terminal apparatus 21, searches and extracts desired electronic data, such as music content, from the database 223 based on the electronic data purchase instruction and the electronic data select instruction, and transmits the extracted electronic data via the communication means 224 to the dedicated terminal apparatus 21 from which the purchase and select instructions were output.

The electronic data extraction control program includes the following sequentially-executed steps: a purchase detection step for using the communication means 224 to receive instructions to purchase and select electronic data from the dedicated terminal apparatus 21 and determining whether or not the received instructions are purchase information; an electronic data extraction step for searching and extracting desired electronic data, such as music content, from the database 223 based on the received electronic data purchase and select instructions; and an electronic data transmitting step for transmitting the extracted electronic data via the communication means 224 to the dedicated terminal apparatus 21 from which the purchase and select instructions were output.

The electronic data storage means 225b performs storage control, based on the electronic data storage control program, such that the communication means 224 receives an electronic data resell instruction and electronic data, such as music content, from the dedicated terminal apparatus 21, and the received data is transferred to a prescribed location in the database 223 based on the electronic data resell instruction.

The electronic data storage control program includes: a resell detection step for using the communication means 224 to receive an electronic data resell instruction and electronic data, such as music content, from the dedicated terminal apparatus 21 and determining whether or not the received resell instruction is resell target information; and a storage step for performing storage control by transferring the received electronic data to a prescribed location in the database 223 when the received resell instruction is the resell target information. The electronic data storage control program may include another storage step for performing storage control so as to store the received purchase money or resale money at a prescribed location in the database 223. In this case, the electronic data distribution server 22 can collectively manage the amount of money that is paid and/or returned.

The electronic data transfer-purchase processing means includes the above-described electronic data transfer-purchase setting processing means 218a and electronic data extraction processing means 225a. The electronic data transfer-purchase processing means performs electronic data transfer-purchase processing for transfer-purchasing desired electronic data from an operator side storage section (the database 223) through a network and the dedicated terminal apparatus 21 to a purchaser-side storage section (memory means including a semiconductor memory M). The electronic data transfer-resell processing means includes the electronic data transfer-resell setting processing means 218b and the electronic data storage means 225b. The electronic data transfer-resell processing means performs electronic data transfer-resell processing for transfer-reselling electronic data desired to be sold from a reseller-side storage section (memory means including a semiconductor M) through the dedicated terminal apparatus 21 and the network to the operator-side storage section (database 223).

The electronic data transaction control program includes the server-side control program and the terminal-side control program, as described above. Specifically, the electronic data transfer-resell control program includes the electronic data transfer-resell setting program and the electronic data storage control program. An electronic data sell-transferring step is recorded in readable recording media (the ROMs 211 and 221) for allowing computers (the CPUs 218 and 225) to execute a data transfer operation for transferring desired copyright-protected electronic data from the seller's semiconductor memory M through the dedicated terminal apparatus 21 to an input/output dedicated system (the electronic data distribution server 22) connected to the dedicated terminal apparatus 21 via a network.

The set detection step is common to the electronic data transfer-purchase setting control program and the electronic data transfer-resell setting control program and can be shared between these programs. The purchase instruction step of the electronic data transfer-purchase setting control program and the resell instruction step of the electronic data transfer-resell setting control program determine whether or not either a purchase instruction or a resell instruction has been input. However, by detecting whether or not the purchase instruction has been input, the resell instruction can be determined to have been input when the purchase instruction was not input.

An operation of the electronic data transaction system 1 will be described below.

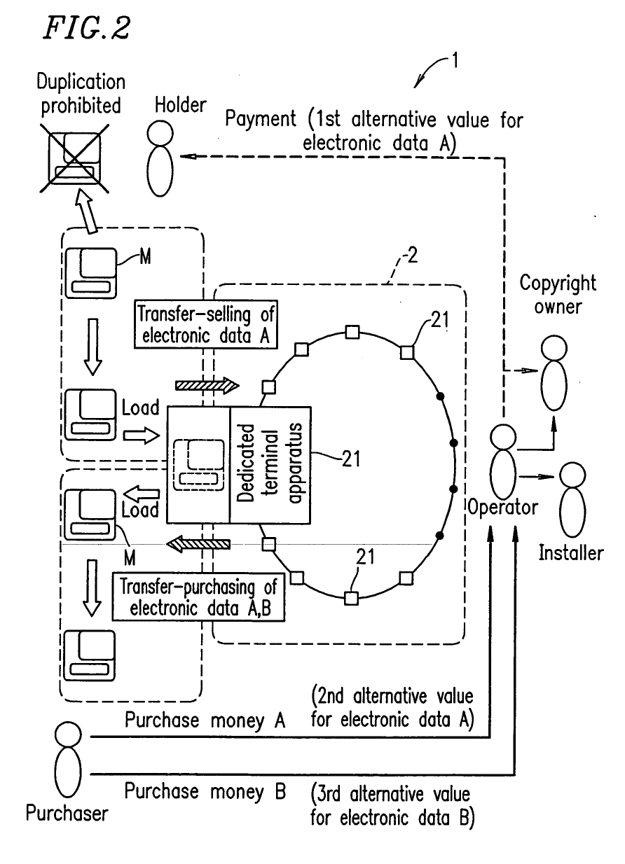

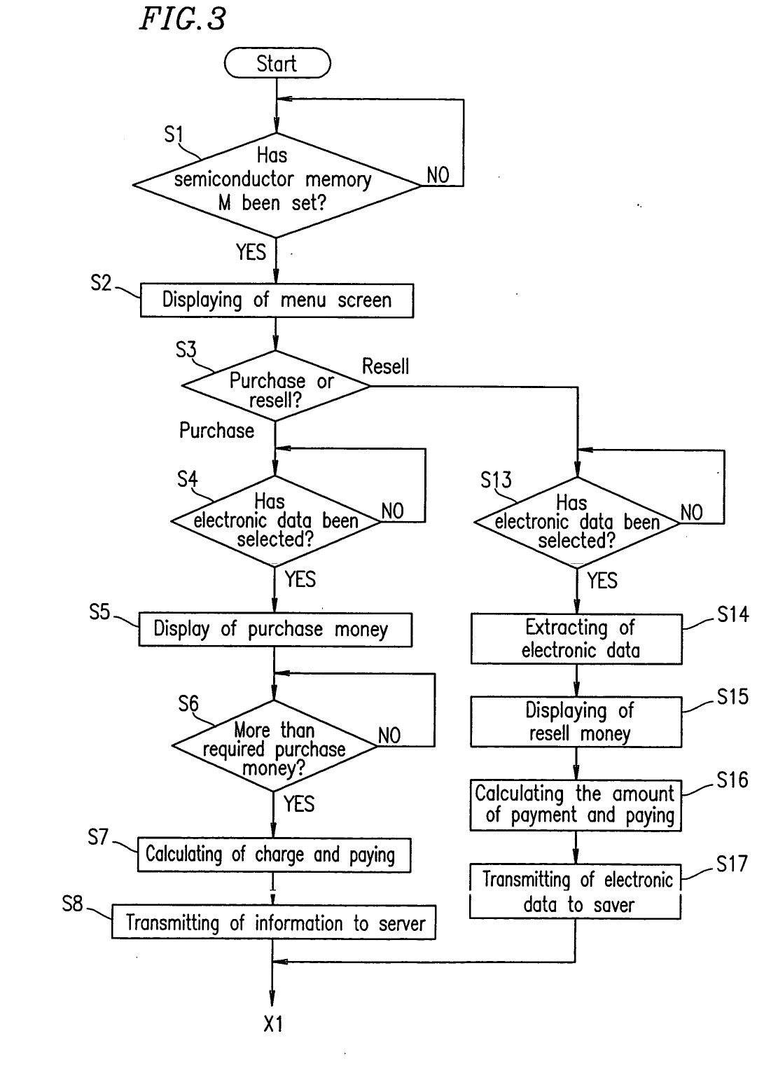

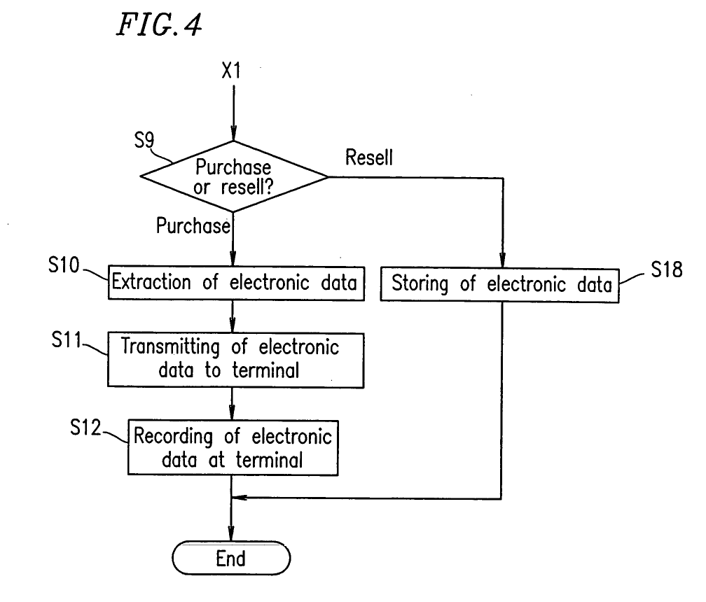

FIG. 2 is a diagram schematically illustrating an operation status of the electronic data transaction system 1 of FIG. 1. FIGS. 3 and 4 form a flowchart illustrating the operation of the electronic data transaction system 1 of FIG. 1.

Referring to FIGS. 2 and 3, a purchaser (consumer) who wants to purchase copyright-protected electronic data (e.g., music content) brings a semiconductor memory M to, for example, a convenience store in which a dedicated terminal apparatus 21 is installed and loads the semiconductor memory M into the dedicated terminal apparatus 21.

At step S1, the control means 218 determines whether or not the purchaser's semiconductor memory M has been set in a prescribed position within the data recording/reproducing means 215. When the semiconductor memory M is determined to have been set (YES), a menu screen is extracted from the ROM 211 and is displayed on the display screen of the display means 213 at step S2. The user uses the operating means 214 to make a selection from items displayed on the screen while referring to the display screen (the menu screen) of the display means 213. The selection is carried out via the key switches or touch panel of the operating means 214. Then, at step S3, the control means 218 determines whether purchase processing or resell processing has been selected. When the purchase processing is determined to have been selected, a purchase instruction is generated for purchasing desired music content. Further, at step S4, the control means 218 determines whether or not the desired music content has been selected via the key switches or touch panel of the operating means 214 and generates a select instruction to select the desired music content.

Furthermore, at step S5, the control means 218 extracts the amount of purchase money for electronic data selected to purchase from a charge table, which is stored in the ROM 211 and associated with new and old versions of that electronic data, and display the purchase amount extracted on the display screen of the display means 213.

Purchase money B for a piece of electronic data (e.g., ¥500 per piece of music in the case of music content) is paid as the third alternative value for electronic data B that the purchaser wants to purchase through the charge input/output means 216 to the dedicated terminal apparatus 21.

In this case, at step S6, the control means 218 determines whether or not the charge input/output means 216 has detected the amount of money equal to or greater than that required for transfer-purchasing the electronic data. Then, at step S7, the control means 218 makes a calculation so as to deduct the amount extracted at step S5 from the total sum of paid money detected by the charge input/output means 216, and controls the charge input/output means 216 so as to return the calculated amount of money (change) from the change return thereof.

At step S8, the control means 218 transmits a purchase instruction and selection information, which are related to the desired music content, to the electronic data distribution server 22 via the communication means 217. In this case, the amount extracted (purchase money) may be transmitted simultaneously.

Referring to FIGS. 2 and 4, in the electronic data distribution server 22, the control means 225 determines, at step S9, whether a purchase instruction or a resell instruction has been received. When the purchase instruction is determined to have been received, the desired electronic data, such as music content, is searched through the database 223 based on the received purchase and select instructions and extracted therefrom at step S10.

Next, at step S11, the control means 225 transmits the extracted electronic data via the communication means 224 to the dedicated terminal apparatus 21 from which the purchase and select instructions were output.

The operation continues in the dedicated terminal apparatus 21. At step S12, the control means 218 controls the communication means 217 so as to receive electronic data for the desired music content transmitted from the electronic data distribution server 22 and the data recording/reproducing means 215 so as to record the received electronic data for the desired music content to the purchaser's semiconductor memory M. In this manner, the desired electronic data B is transfer-purchased from the dedicated terminal apparatus 21.

In this case, the electronic data transaction system 1 is networked using optical fibers, and therefore electronic data B is transferred via the input/output dedicated system 2 at, for example, 3 M bits/sec. and is recorded to the semiconductor memory M. Accordingly, the purchaser can enjoy desired electronic data B as his/her purchase using his/her own semiconductor audio player. Although purchase money B paid through the dedicated terminal apparatus 21 goes to the operator, the operator returns portions of purchase money B to the installer of the dedicated terminal apparatus and the copyright owner of electronic data B who is also the provider thereof.

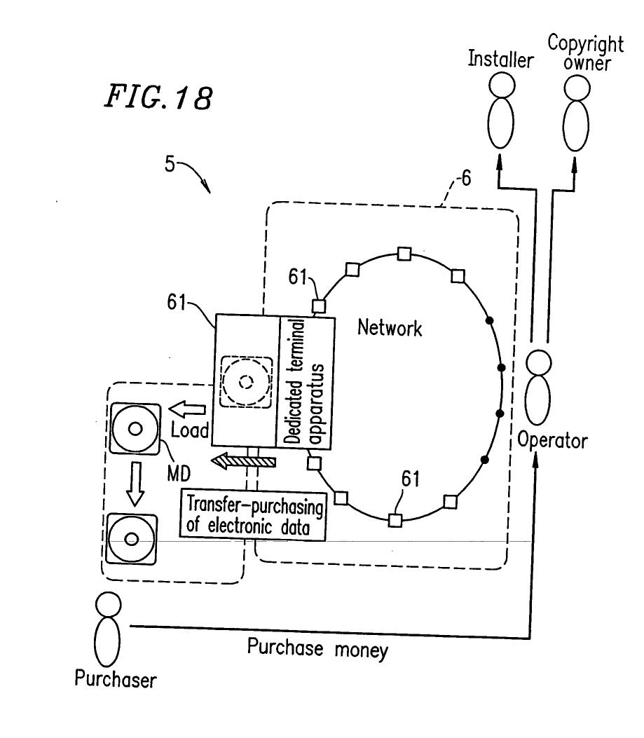

The operation form described so far is substantially the same as that described with respect to the first conventional example and with reference to FIG. 18. It can be said that this is the legitimate route for purchasing electronic data B. An operation of an electronic data transaction system 1 shown in each of FIGS. 2-4 associated with features of the present invention will be described in detail below.

The purchaser who purchased copyright-protected electronic data B through the above-described legitimate route becomes the holder of electronic data B recorded on the semiconductor memory M. The holder who is a consumer can enjoy desired music as his/her purchase by reproducing electronic data B such as music content.

Here, provided that music content used for two years after the purchase of electronic data B is electronic data A, when the holder determines that electronic data A is not necessary and the holder does not want to keep electronic data A, the holder brings the semiconductor memory M to a convenience store or the like in which the dedicated terminal apparatus 21 is installed and inserts the semiconductor memory M into the dedicated terminal apparatus 21.

As shown in FIGS. 2 and 3, firstly, the control means 218 determines whether or not the semiconductor memory M has been set at step S1, and displays the menu screen at step S2. While referring to the display screen, the user makes a selection from among items shown on the screen via key switches and the touch panel of the operating means 214. When reselling processing is determined to be selected at step S3, the control means 218 generates an instruction to resell electronic data.

Next, at step S13, the control means 218 determines whether music content desired to be sold has been selected via the key switches or the touch panel of the operating means 214. When the music content desired to be sold is determined to have been selected, the control means 218 generates an instruction to select the music content.

Further, at step S14, the control means 218 controls, based on the select instruction, the electronic data recording/reproducing means 215 so as to search and extract (read) the electronic data desired to be sold from the reseller's semiconductor memory M.

At step S15, the control means 218 extracts, based on the select instruction, the resell price of the sold electronic data from a charge table, which is stored in the ROM 211 and associated with new and old versions of the sold electronic data, and displays the resell price on the display screen of the display means 213.

At step S16, the control means 218 calculates the amount of payment by adding the amount extracted (resale money) to the total sum detected by the charge input/output means 216 and controls the charge input/output means 216 to return the calculated amount of money from the change return thereof.

At step S17, the control means 218 transmits the extracted electronic data to the electronic data distribution server 22 via the communication means 217.

Referring to FIGS. 2 and 4, in the electronic data distribution server 22, the control means 225 determines, at step S9, whether a purchase instruction or a resell instruction has been received. When the resell instruction is determined to have been received, the received electronic data is transferred to and stored at a prescribed location within the database 223 based on the resell instruction.

As described above, when the holder wants to sell electronic data A, the holder uses the dedicated terminal apparatus 21 to search his/her electronic data A and transfer electronic data A to the database 223 of the electronic data distribution server 22 in the input/output dedicated system 2, in which case the holder does not keep a duplicate of electronic data A. As the first alternative value for electronic data A, the reseller receives a portion of payment for a piece of electronic data, e.g., a piece of music data, (e.g., ¥100 per piece of music in the case of music content) from the dedicated terminal apparatus 21. The reseller receives the portion of the payment from the operator, and the operator returns other portion of the payment to the copyright owner of electronic data A who is also the provider thereof.

Specifically, according to the electronic data transaction system 1, when copyright-protected electronic data is intangible, the holder can onerously deliver over electronic data A to the operator.

As described above in the present embodiment 1, in addition to copyright-protected electronic data B purchased through the electronic data transaction system 1 of FIG. 1 as the legitimate route for purchasing, electronic data A (aged electronic data B) transferred by the holder via the input/output dedicated system 2 to the database 313 of the electronic data distribution server 22 is targeted for purchasing to the purchaser. Specifically, when the purchaser who is a consumer wants to purchase even non up-to-date electronic data A (e.g., non-latest and aged music content used for a considerable time period), the purchaser brings his/her own semiconductor memory M to a convenience store or the like in which the dedicated terminal apparatus 21 is installed, and loads the semiconductor memory M into the dedicated terminal apparatus 21. As the second alternative value for desired electronic data A selected and searched by the purchaser using the dedicated terminal apparatus 21, the purchaser pays to the dedicated terminal apparatus 21 purchase money A, e.g., approximately ¥300 per piece of electronic data (a piece of music in the case of music content), and transfer-purchases electronic data A via the input/output dedicated system 2, from the database 313 of the electronic data distribution server 22 to the dedicated terminal apparatus 21. Purchase money A is set so as to have a value lower than that of the above-described purchase money B. Specifically, according to the electronic data transaction system 1, when copyright-protected electronic data is intangible, the operator can sell the electronic data at second hand to the purchaser (consumer).

Therefore, according to Embodiment 1 described with reference to FIGS. 1-4, the user goes to the dedicated terminal apparatus 21 installed in a convenience store or the like and can perform a transaction of electronic data, such as music content, desired to purchase or sell. In this case, based on the market awareness that the purchase price for aged electronic data A used for a certain period of time is required to be lower than that for electronic data B transfer-purchased anew, aged electronic data A used for a certain period of time can be put on the market for new electronic data B, whereby it is possible to build a new business model which expands the electronic data transaction market.

(Embodiment 2)

Embodiment 1 is directed to the case where the user goes to the dedicated terminal apparatus 21 installed in a convenience store or the like and performs a transaction of electronic data, such as music content, desired to purchase or sell, while Embodiment 2 is directed to the case where a personal computer is used as a user terminal apparatus connectable to the Internet so as to perform a transaction of electronic data, such as music content, desired to purchase or sell.

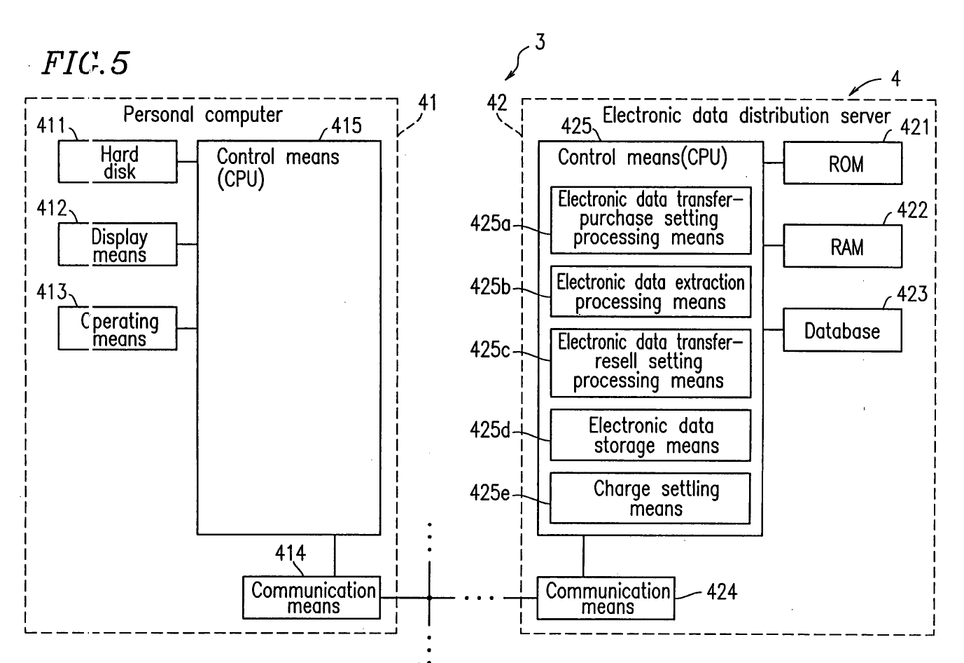

FIG. 5 is a diagram illustrating a structure of an exemplary electronic data transaction system according to Embodiment 2 of the present invention. In FIG. 5, the operator operates an electronic data transaction system 3 including an input/output dedicated system 4 networked via the Internet. Specifically, the operator uses the network formed by internet connections so as to construct the input/output dedicated system 4 as the electronic data transaction system 3. Accordingly, the input/output dedicated system 4 is connected to countless of personal computers 41 as user terminal apparatuses and to other computers.

The input/output dedicated system 4 includes an electronic data distribution server 42 having a database 423 in which a variety of types of copyright-protected electronic data, such as music content, are registered. The personal computers 41 and the electronic data distribution server 42 are connected such that data exchange between them can be performed via the Internet. Specifically, the input/output dedicated system 4 allows the purchaser to download electronic data to his/her personal computer 41 via a network constructed by using internet connections at the demand of the consumer. When electronic data A and B are music contents, the electronic data transaction system 3 can be categorized as an EMD (Electronic Media Distribution) system using electronic distribution terminal apparatuses (the personal computers 41 as the user terminal apparatuses).

A personal computer 41 includes: a hard disc 411 as storage means; display means 412; operating means 413 such as a keyboard, a mouse, etc.; communication means 414 for performing data communication with the electronic data distribution server 42; and control means 415 for controlling these components and capable of controlling internet connections.

The electronic data distribution server 42 includes: a ROM 421 as read-only data storage means; a RAM 422 as a work memory (temporary data storage means); a database 423 in which a variety of types of copyright-protected electronic data such as music content; communication means 424 for performing data communication with the personal computers 41; and control means 425 for controlling these components.

The control means 425 includes a CPU (central processing unit) which includes: electronic data transfer-purchase setting processing means 425a for performing, based on a control program, electronic data transfer-purchase setting processing from the side of the electronic data distribution server 42 according to an operation instruction provided by the personal computer 41; electronic data extraction processing means 425b for extracting electronic data desired to purchase according to the electronic data transfer purchase setting processing; electronic data transfer-resell setting processing means 425c as electronic data transfer-sell setting processing means for performing electronic data transfer-resell setting processing from the side of the electronic data distribution server 42; electronic data storage means 425d for transferring electronic data desired to be sold for storage according to the electronic data transfer-resell setting processing; and charge settling means 425e for performing charge settling processing for settling the charge in response to the electronic data transfer-purchase processing or the electronic data transfer-resell processing.

As will be described in detail below, the server-side control program includes an electronic data transfer-purchase control program, an electronic data transfer-resell control program, and a charge settling control program.

The electronic data transfer-purchase setting processing means 425a controls, based on the electronic data transfer-purchase control program, the operating means 413 from the side of the electronic data distribution server 22 via the communication means 414 and the Internet, so as to set a purchase instruction to purchase desired music content and a select instruction to search and select desired music content. The electronic data transfer-purchase setting processing means 425a also performs data transfer-purchase setting processing for transfer-purchase transmitted desired electronic data from the electronic data distribution server 42 through the Internet to the hard disc 411.

The electronic data extraction processing means 425b searches and extracts electronic data, such as music content, desired to purchase from the database 423 based on electronic data purchase and select instructions provided from the personal computer 41 and transmits, based on the electronic data transfer-purchase control program, the extracted desired data via the Internet from the communication means 424 to the personal computer 41 of the purchaser who set the purchase and select instructions.

The electronic data transfer-purchase control program includes the following sequentially-executed steps: a purchase instruction step for determining whether or not a purchase instruction to purchase desired music content has been input by the personal computer 41; a select instruction step for determining whether or not a select instruction to select the desired music content has been input by the personal computer 41; an electronic data extraction step for searching and extracting the electronic data, such as music content, desired to purchase from the database 423 according to the purchase and select instructions; and an electronic data transmitting step for transmitting the extracted desired electronic data from the communication means 424 via the Internet to the personal computer of the purchaser who input the purchase and select instructions.

The electronic data transfer-resell setting processing means 425c performs electronic data transfer-resell setting processing based on the electronic data transfer-resell control program by searching and extracting desired electronic data from among pieces of electronic data recorded in the hard disc 411 according to a select instruction provided by the operating means 413, and transmitting the extracted electronic data from the communication means 414 to the electronic data distribution server 42 via the Internet.

The electronic data storage means 425d performs storage control based on the electronic data transfer-resell control program such that the purchaser's personal computer 41 sets an electronic data resell instruction, the communication means 424 receives music content transmitted from the communication means 414 of the personal computer 41 via the Internet, and the received desired electronic data is transfer to a prescribed location within the database 423.

The electronic data transfer-resell control program includes the following sequentially-executed steps: a resell instruction step for determining whether or not a resell instruction to sell music content desired to be sold has been input by the personal computer 41; a select instruction step for determining whether or not a select instruction to select the desired music content has been input by the personal computer 41; and a storage step for transferring the electronic data targeted for reselling, which has been transmitted from the personal computer 41, to a prescribed location within the database 423. Specifically, similar to Embodiment 1, the electronic data transfer-resell control program includes the electronic data transfer-resell setting control program and the electronic data storage control program. An electronic data sell-transferring step is recorded in a readable recording medium (the ROM 421) for allowing a computer (the CPU 425) to execute a data transfer operation for transferring desired copyright-protected electronic data from the seller's semiconductor memory M through the personal computer 42 to an input/output dedicated system (the electronic data distribution server 42) connected to the personal computer 42 via a network (the Internet).

Based on the charge settling program, the charge settling means 425e extracts and determines the amount of purchase money for purchased electronic data or the amount of resale money for sold electronic data from a table, which is stored in the ROM 421 and associated with new and old versions of the purchased or sold electronic data.

The charge settling control program includes a purchase money extraction step for searching and extracting the amount of purchase money for the purchased electronic data according to a purchase instruction from the table, which is stored in the ROM 421 and associated with new/old version of the electronic data, and a resale money extraction step for searching and extracting, according to a resell instruction, the amount of resale money for the sold electronic data from the table, which is stored in the ROM 421 and associated with new/old versions of the electronic data.

The electronic data transfer-purchase processing means includes the electronic data transfer-purchase setting processing means 425a and the electronic data extraction processing means 425b, as described above. The electronic data transfer-purchase processing means performs electronic data transfer-purchase processing by using the personal computer 41 so as to transfer-purchase desired electronic data from an operator-side storage section (the database 423) to a purchaser-side storage section (the hard disc 411) via a network. The electronic data transfer-resell processing means includes the electronic data transfer-resell setting processing means 425c and the electronic data storage means 425d. The electronic data transfer-resell processing means performs electronic data transfer-resell processing by using the personal computer 41 so as to transfer-resell electronic data desired to be sold from a reseller-side storage section (the hard disc 411) to the operator-side storage section (the database 423) via the network.

An operation of the electronic data transaction system 3 will be described below.

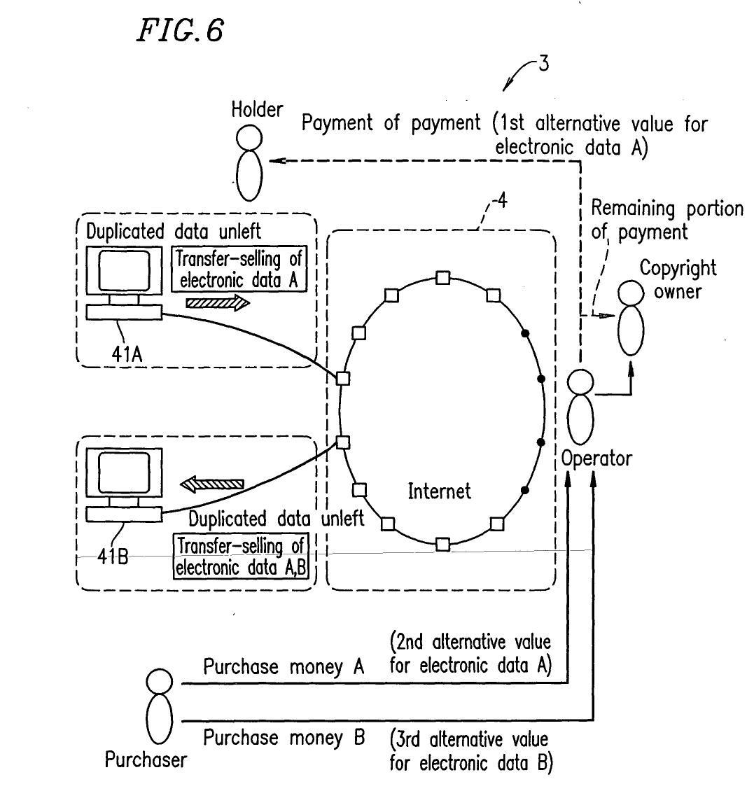

FIG. 6 is a diagram schematically illustrating an operation status of the electronic data transaction system 3 of FIG. 5. FIG. 7 is a flowchart illustrating the operation of the electronic data transaction system 3 of FIG. 5.

Referring to FIGS. 6 and 7, a purchaser (consumer) who wants to purchase copyright-protected electronic data (e.g., music content) connects his/her personal computer 41B to the Internet (network 2). Mutual authentication between the electronic data distribution server 42 in the input/output dedicated system 4 and the personal computer 41B is performed via the Internet. If the authentication is correctly performed, the personal computer 41B is connected to the electronic data distribution server 42 in the input/output dedicated system 4, whereby it is possible to control the electronic data distribution server 42 using the personal computer 41B.

Firstly, at step S21, the electronic data transfer-purchase setting processing means 425a transmits menu screen data for electronic data transaction to the personal computer 41B according to an operation instruction provided by the personal computer 41B in order to display a menu screen on the display screen of the personal computer 41B.

Next, the user performs an operation for selecting purchasing or reselling of electronic data while referring to the menu screen, so that the operation instruction for selection is provided from the personal computer 41B and input to the electronic data distribution server 42 via the Internet. At step S22, the electronic data transfer-purchase setting processing means 425a determines whether or not an electronic data purchase instruction has been provided by the personal computer 41B.

The user uses the personal computer 41B to demand electronic data B (e.g., music content) that he/she wants from the electronic data distribution server 42. Specifically, when the user performs an operation for selecting desired music content, an operation instruction selected by the personal computer 41B is input to the electronic data distribution server 42. At step S23, the electronic data transfer-purchase setting processing means 425a determines whether or not the instruction to select the desired music content has been provided by the personal computer 41.

As described above, responsive to the demand (purchase and select instructions), the electronic data extraction processing means 425b searches and extracts the desired music content from the database 423 according to the purchase and select instructions at step S24.

At step S25, the electronic data distribution server 42 enciphers the extracted desired electronic data B and distributes the enciphered data from the communication means 424 through the Internet to the personal computer 41 of the purchaser who input the purchase and select instructions.

In the case where the purchase instruction is provided, at step S26, the charge settling means 425e searches and extracts the amount of purchase money for the purchased electronic data from a table which is stored in the ROM 421 and associated with new/old versions of the electronic data.

At step S27, the electronic data distribution server 42 transmits data representing the amount of purchase money for the electronic data to the personal computer 41B in order to display the extracted amount of purchase money on the display screen of the personal computer 41B.

At step S28, the electronic data distribution server 42 stores the data representing the extracted amount of purchase money at a prescribed location within the database 423 for management use.

By distributing desired electronic data B in a manner as described above, electronic data B is stored in the hard disc 411 of the personal computer 41B, thereby completing transfer-purchasing. Electronic data B can be deciphered and reproduced by the personal computer 41B.

As the third alternative value for electronic data B, the purchaser pays purchase money B per piece of electronic data (e.g., ¥500 per piece of music in the case of music content) for transfer-purchasing electronic data B from the input/output dedicated system 4.

The purchaser can enjoy desired electronic data B as his/her purchase using his/her personal computer 41B or portable terminal apparatus. Although purchase money B paid through the input/output dedicated system 4 goes to the operator, the operator returns a portion of purchase money B to the copyright owner of electronic data B who is also the provider thereof.

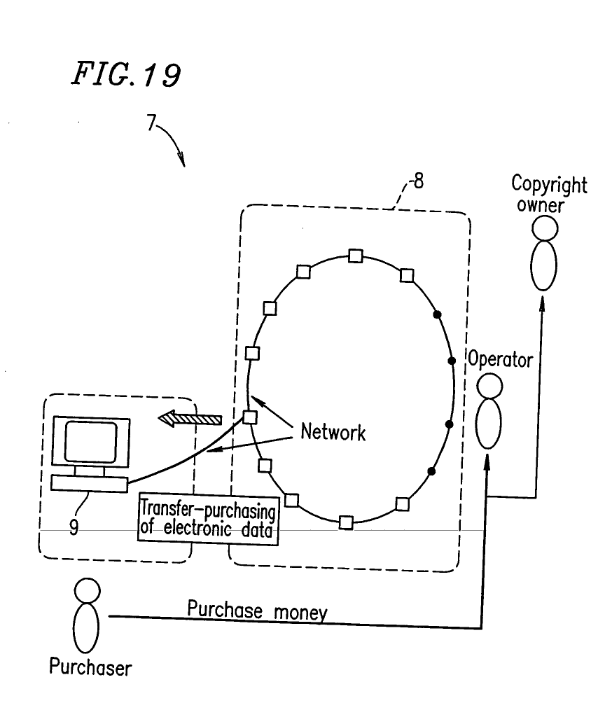

The operation form described so far is substantially the same as that described with respect to the second conventional example and with reference to FIG. 19. It can be said that this is the legitimate route for purchasing electronic data B. An operation of an electronic data transaction system 3 shown in FIG. 5 associated with features of the present invention will be described in further detail below.

The purchaser who purchased copyright-protected electronic data B through the above-described legitimate route becomes the holder of electronic data B recorded on the hard disc 411 of his/her personal computer 41B. The holder who is a consumer can enjoy, for example, music content derived from electronic data B as his/her purchase.

Here, provided that aged music content used for two years after the purchase of electronic data B owned by the holder is electronic data A, when the holder determines that the holder does not want to keep electronic data A and electronic data A is not necessary, the holder who is a consumer connects his/her personal computer 41B to the Internet (network) so as to perform mutual authentication between the electronic data distribution server 42 in the input/output dedicated system 4 and the personal computer 41B. If the authentication is correctly performed, the personal computer 41B is connected to the electronic data distribution server 42 in the input/output dedicated system 4, whereby it is possible to control the electronic data distribution server 42 using the personal computer 41B.

As described above, firstly, at step S21, the electronic data distribution server 42 transmits menu screen data to the personal computer 41B via the Internet according to an operation instruction provided from the personal computer 41B. Next, the user selects “resell electronic data” while referring to the menu screen, so that the operation instruction selected by the personal computer 418 is input to the electronic data distribution server 42. At step S22, the electronic data transfer-resell setting processing means 425c determines whether or not an instruction to resell electronic data has been provided by the personal computer 41B.

The user uses the personal computer 41B so as to instruct the electronic data distribution server 42 to search information regarding electronic data A owned by himself/herself. Specifically, responsive to the information search instruction, the electronic data transfer-resell setting processing means 425c transmits to the personal computer 41B information from a table which is stored in the ROM 421 and associated with new/old versions of that electronic data. The transmitted table information is displayed on the display screen of the personal computer 41B. The user selects electronic data A (e.g., music content) that the user wants to sell. Specifically, when the user performs an operation for selecting music content desired to be sold, an instruction to perform the select operation is transmitted from the personal computer 41B to the electronic data distribution server 42. At step S29, the electronic data transfer-resell setting processing means 425c determines whether or not the instruction to select desired music content has been provided by the personal computer 41.

At step S30, the electronic data targeted for reselling transmitted by the personal computer 41 is stored at a prescribed location within the database 423.

In the case where a resell instruction is provided, at step S31, the charge settling means 425e searches and extracts the amount of resale money for the sold electronic data from a table, which is stored in the ROM 421 and associated with new/old versions of the sold electronic data.

At step S32, the electronic data distribution server 42 transmits data representing the amount of resale money for the sold electronic data to the personal computer 41B in order to display the extracted amount of resale money on the display screen of the personal computer 41B.

At step S33, the electronic data distribution server 42 stores the extracted data representing the amount of resale money at a prescribe location within the database 423 for management use.

As described above, the holder uses the personal computer 41B so as to search through the electronic data distribution server 42 for information regarding his/her electronic data A. When the holder wants to sell the electronic data, the holder uses the personal computer 41B so as to transfer electronic data A to the electronic data distribution server 42 in the input/output dedicated system 4 via a network (the Internet), in which case the holder does not keep a duplicate of electronic data A.

As the first alternative value for electronic data A, the holder can receive a portion of payment for a piece of electronic data (e.g., ¥100 per piece of music in the case of music content). The operator returns other portion of the payment to the copyright owner of electronic data A who is the original provider thereof. Specifically, when copyright-protected electronic data is intangible, the electronic data transaction system 3 allows the holder to onerously deliver over the electronic data to the operator.

In addition to copyright-protected electronic data B purchased through the electronic data transaction system 3 of FIG. 5 as the legitimate route for purchasing, electronic data A transferred by the holder to the input/output dedicated system 4 is targeted for purchasing to the purchaser. Specifically, when the purchaser who is a consumer wants to purchase even non up-to-date electronic data (e.g., non-latest and aged music content used for a considerable time period), the purchaser connects his/her personal computer 41B to the electronic data distribution server 42 in the input/output dedicated system 4 via the Internet (a network), so as to pay, to the electronic data distribution server 42, purchase money A, e.g., approximately ¥300 per piece of electronic data (a piece of music in the case of music content), as the second alternative value for electronic data A desired to purchase and searched for through the electronic data distribution server 42, thereby transfer-purchasing electronic data A from the electronic data distribution server 42. Purchase money A is set so as to have a value lower than that of the above-described purchase money B. Specifically, according to the electronic data transaction system 3, when copyright-protected electronic data is intangible, the operator can sell the electronic data at second hand to the purchaser (consumer).

Therefore, according to Embodiment 2 described with reference to FIGS. 5-7, desired electronic data, such as music content, can be purchased and sold using the personal computer 41 as a user terminal apparatus connectable to the Internet. In this case, based on the market awareness that the purchase price for aged electronic data A used for a certain period of time is required to be lower than that for electronic data B transfer-purchased anew, aged electronic data A used for a certain period of time can be put on the market for new electronic data B, whereby it is possible to build a new business model which expands the electronic data transaction market.

(Embodiment 3)

Embodiment 3 is directed to the case where a display screen, which includes listings of specific types of electronic data to be transfer-purchased and transfer-sold and respective listings of alternative values for the specific types of electronic data, is displayed on the display and the user performs electronic data transaction while referring to the display screen.

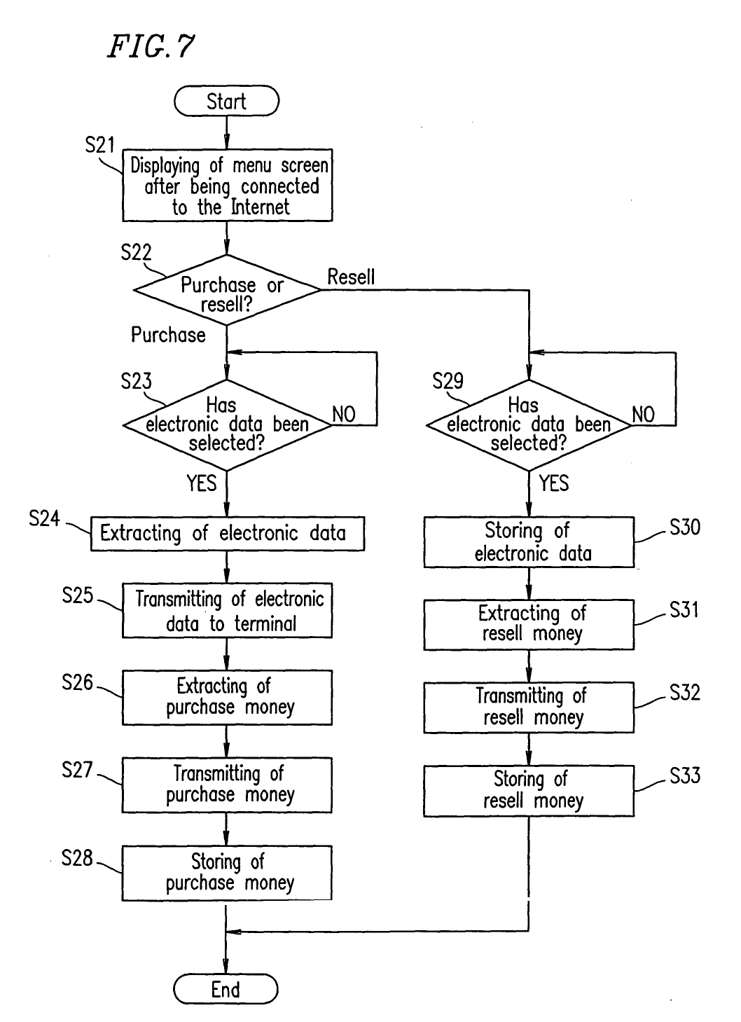

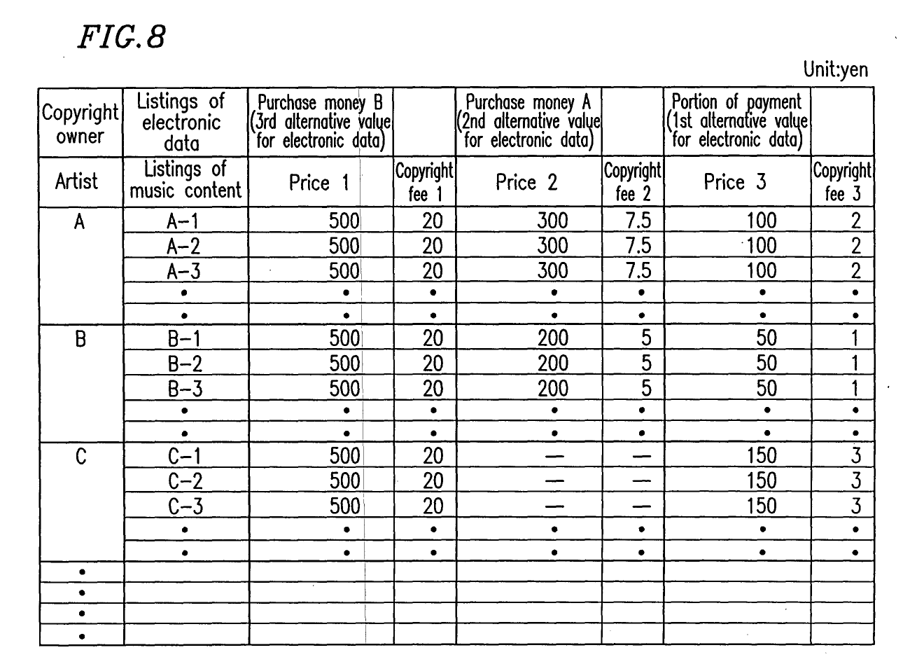

FIG. 8 is a diagram illustrating a display screen of the dedicated terminal apparatus 21 shown in FIG. 1 or the personal computer 41 shown in FIG. 5 when connected to an input/output dedicated system. The first row of the list shown in FIG. 8 is illustrated for the purpose of explaining Embodiment 3, and the actual display screen includes the list of FIG. 8 from the second row downward.

In FIG. 8, when electronic data is music content, listings of “music content” by “Artist” are shown. The “music content” and “Artist” are explained in Embodiments 1 and 2 as the “electronic data” and “copyright owner”, respectively. “Price 1” corresponding to the “music content” shows the amount of money paid to the operator when the purchaser purchases a so-called newly-released electronic data (music content). This corresponds to purchase money B (the third alternative value for electronic data) in Embodiments 1 and 2. “Copyright fee 1” shows a portion of “Price 1” which is returned to the copyright owner.

“Price 3” corresponding to “music content” shows the amount of money paid by the operator to the holder of electronic data (music content) when the holder determines that such electronic data is not necessary and sells the electronic data to the input/output dedicated system 2 or 4. The amount of money corresponds to a portion of the payment (the first alternative value for electronic data) in Embodiments 1 and 2. “Copyright fee 3” shows the remaining portion of the payment which is returned to the copyright owner.

“Price 2” corresponding to “music content” shows the amount of money paid by the purchaser to the operator, for example, when the operator sells, at second hand, aged electronic data used for, for example, two years after the purchase, which is sold by the holder to the input/output dedicated system 2 or 4 at “Price 3”. This corresponds to purchase money A (the second alternative value for electronic data) in Embodiments 1 and 2. “Copyright fee 2” shows a portion of “Price 2” which is returned to the copyright owner.

In this manner, in addition to respective listings of pieces of electronic data to be transferred to the dedicated terminal apparatus 21 or the personal computer 41, which is a user terminal apparatus, at least either respective listings of alternative values to be received or respective listings of portions of alternative values to be provided to copyright owners are displayed. This allows a consumer who is the holder or the purchaser to consentingly conduct electronic data transaction with reference to alternative values for electronic data on the display screen.

In this case, Prices 1, 2, and 3 are different among Artists A, B, C, etc. This indicates that as compared to Artist A, resale values for music content of Artist B is low and resale values for music content of Artist C is high. In particular, Price 2 is not available for Artist C, which indicates that no music content available for secondhand selling is present in the input/output dedicated system 2 or 4.

As described above, according to Embodiment 3, the following effects are achieved by providing a function of displaying the display screen as shown in FIG. 8 to the electronic data transaction system 1 or 3 according to Embodiment 1 or 2 in which copyright is granted each time secondhand selling is performed so that the amount of money corresponding to an alternative value is returned to the copyright owner. Specifically, transaction achieves effect not only of accelerating secondhand selling and reselling of electronic data but also of increasing returns to the copyright owner as the frequency of secondhand selling of electronic data is increased, that is, as the market value of the electronic data is increased. This is because the business model is based on the market competition mechanism. From the viewpoint of consumers (purchasers), in the case where electronic data is initially purchased through the legitimate route, returns to the copyright owner is required to be small as compared to the case where the electronic data is provided in the tangible form (e.g., in the form of a reproduction-only optical disc (the ROM form)). Accordingly, there is a possibility that the price for electronic data might be reduced.

(Embodiment 4)

Embodiment 4 is directed to the case where a “content ID” and/or a “cryptographic content-specific key” are transferred along with electronic data so that duplication of the electronic data is prohibited in the source of the transferred electronic data.

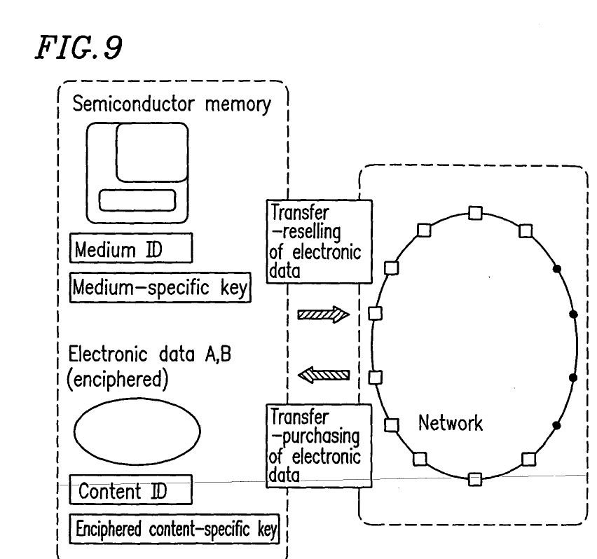

FIG. 9 is a diagram schematically illustrating an operation status of an electronic data transaction system according to Embodiment 4 of the present invention. It should be noted that Embodiment 4 is applicable to Embodiment 1 where the semiconductor memory M and electronic data A and B are employed and Embodiment 2 where the hard disc 411 and electronic data A and B are employed.

In FIG. 9, copyright-protected electronic data has a “content ID” and a “cryptographic content-specific key” recorded therein in order to prohibit the electronic data from being duplicated in the source from which the electronic data is transferred. Alternatively, in the system where a recording medium is employed (Embodiment 1), for example, a semiconductor memory, which is a recording medium, has a “medium ID” and a “medium-specific key” recorded therein in order to prohibit electronic data from being duplicated in the source from which the electronic data is transferred.

When transferring copyright-protected electronic data to and from the input/output dedicated system 2 or 4, as in a manner described in conjunction with Embodiments 1 and 2, at least the “content ID” and the “cryptographic content key” are transferred together with contents of the electronic data. This allows the electronic data to be prohibited from being duplicated in the source from which the electronic data is transferred, thereby realizing the electronic data transaction system 1 or 3 according to Embodiment 1 or 2.

(Embodiment 5)

Although Embodiments 1-4 are described with respect to the case where the holder who sells electronic data is referred to as a reseller, Embodiment 5 is described with respect to the case where the holder of electronic data is the copyright owner of the electronic data. Hereinafter, the term “seller” is used to refer to the reseller and the copyright owner who is the holder of electronic data. Accordingly, in some cases, the holder of electronic data may be identical to the copyright owner and the electronic data owned by the holder may be electronic data originally created by the holder.

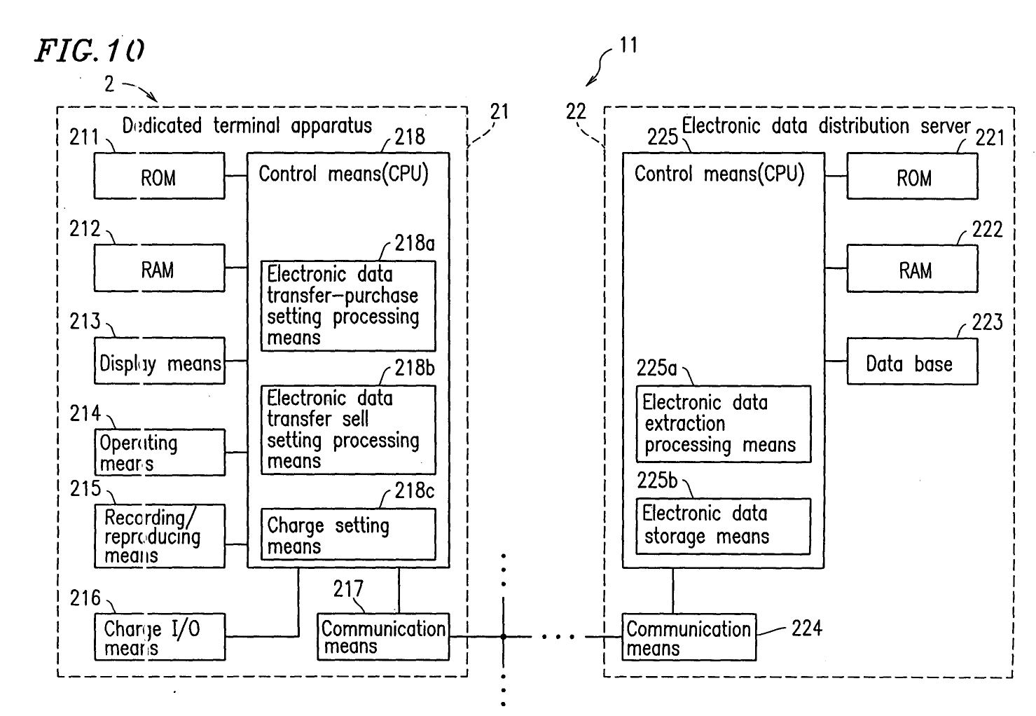

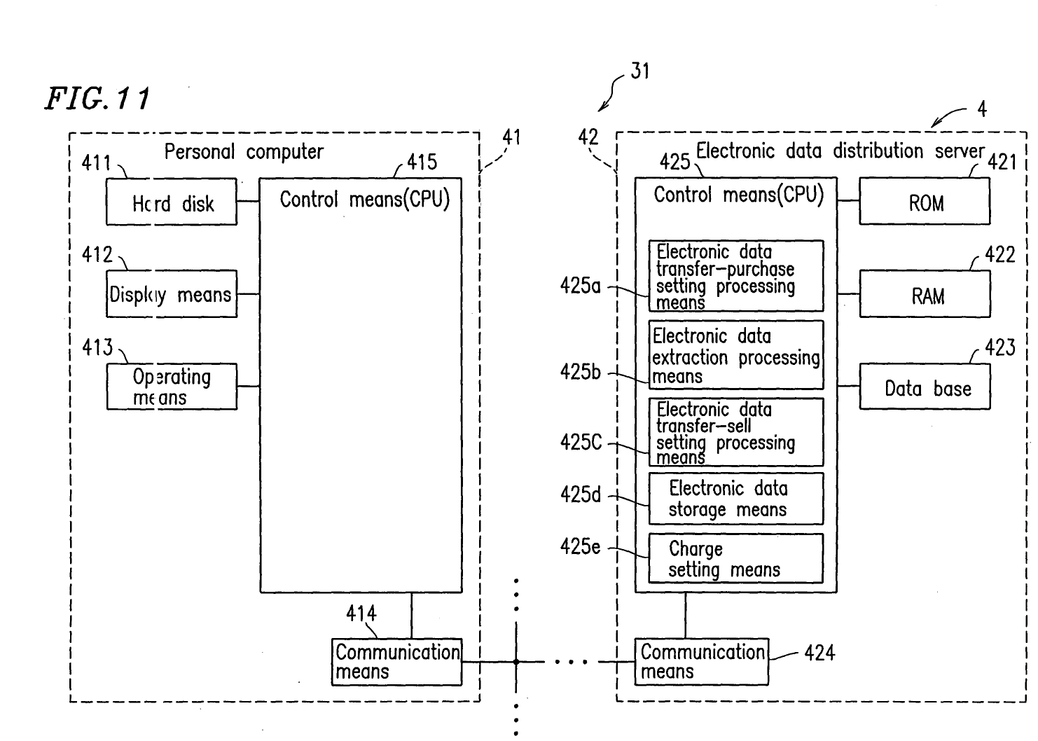

According to Embodiment 5, an electronic data transaction system 11 (including electronic data transfer-sell setting means 218B) of FIG. 10 and an electronic data transaction system 31 (including electronic data transfer-sell setting means 425C) of FIG. 11 are configured such that a general market user (holder) can sell electronic data (e.g., images, such as illustrations and photographs, programs, etc., in addition to music contents) originally created by himself/herself and such electronic data can be resold. In FIGS. 10 and 11, elements similar to those shown in FIG. 1 or 5 are denoted by similar reference numerals, and description thereof will be omitted. Specifically, in Embodiment 5, the seller corresponds to the reseller described in Embodiments 1-4, the data transfer-selling corresponds to data transfer reselling described in Embodiments 1-4, the electronic data transfer-sell setting means 218B shown in FIG. 10 corresponds to the electronic data transfer-resell setting means 218b shown in FIG. 1, and the electronic data transfer-sell setting means 425C of FIG. 11 corresponds to the electronic data transfer-resell setting means 425c of FIG. 5.

When transfer-selling to an input/output dedicated system (electronic data distribution server) is performed, there are three types of alternative value flows as follows. The first flow type is the case where the holder receives an alternative value from the operator, the second flow type is the case where the operator receives an alternative value from the holder, and the third flow type is the case where the holder receives no alternative values. The case where the holder receives no alternative values means, for example, the case where the holder offers to register illustrations originally and satisfactorily created by the holder to the operator-side electronic data distribution server without compensation because the holder wants to spread the illustrations through the market. In such a case, operations are performed in a manner similar to the case where the reseller resells electronic data in Embodiments 1 and 2 and the alternative value for such illustrations is zero. Although the copyright fee is paid to a copyright owner registered in an exceptional manner, copyright fee cannot not be paid to any copyright owners which are not registered in an exceptional manner. Electronic data may be onerously transferred to the purchaser with or without charge at the operator's discretion. When the electronic data is onerous, the operator receives the charge for the electronic data.

Even in this case, the effect of greatly promoting the spread of the electronic data transaction can be achieved in a manner similar to Embodiments 1-4.

In Embodiment 5, the operator can perform processing for protecting copyright (e.g., processing according to Embodiment 4) on electronic data created by the holder (seller or copyright owner).

(Embodiment 6)

Although Embodiments 1-5 are directed to the case where money information (including attributes such as processing dates) regarding transfer-sold or transfer-purchased electronic data is aggregated on an item-by-item basis at the side of a server for registration and management purpose, Embodiment 6 is directed to the case where electronic data itself includes, with or without money information, history information about transfer-sold and transfer-purchased electronic data (including attributes, such as information regarding the number of times of purchasing and aggregated evaluation information (information regarding the number of times of selling and evaluation information) in addition to the processing date). The history information is transferred together with the electronic data.

To explain Embodiment 6 briefly, information regarding the number of times of transfer-selling and transfer-purchasing of electronic data (the number of times of purchasing and selling) is recorded in a prescribed storage section, evaluation information about electronic data based on inputs from the sellers is recorded when the electronic data is transfer-sold, and an aggregated evaluation screen of electronic data based on the number-of-times information and the evaluation information is displayed when the purchaser transfer-purchases electronic data, thereby ensuring that satisfactory electronic data is obtained. Detailed description thereof will be given below.

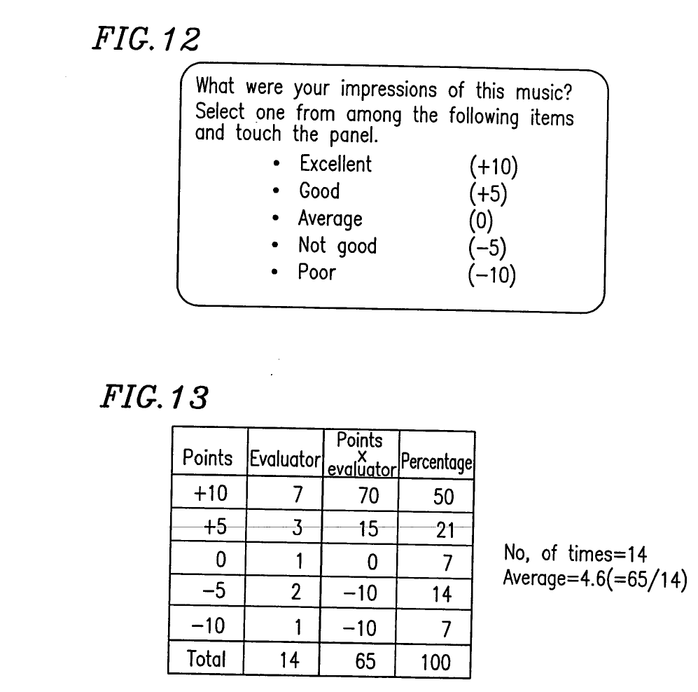

In the case where the user makes any evaluation of, for example, “music data” owned by a user (seller) referring to, for example, a display screen (e.g., a screen on which evaluation information is listed on an item-by-item basis in a graded manner) of a dedicated terminal apparatus, an evaluation selection screen (as shown in FIG. 12) is displayed on the display screen of the dedicated terminal apparatus (e.g., a touch panel is employed as means for selecting items) during transfer-selling of electronic data. In the case where the display screen is of a touch panel-type, by touching with a finger desirable one of evaluation items displayed on the evaluation selection screen as shown in FIG. 12 (or by moving a cursor and clicking a mouse button in the case of a personal computer), it is possible to select any one of the graded evaluation items. The selected evaluation item is transferred as history information together with the electronic data from the dedicated terminal apparatus (or the personal computer) to the electronic data distribution server so that the history information (including the selected evaluation item) and the electronic data are registered in a prescribed storage section of the electronic data distribution server.

In the operator-side electronic data distribution server, for example, the history information is aggregated in the following manner. As shown in the evaluation selection screen of FIG. 12, graded items are displayed in the order of 10, 5, 0, −5, and −10 from the best grade point for making an evaluation when electronic data is sold. Calculation means (not shown) calculates a weighted average value using grade points. Moreover, each time electronic data is sold, the number of time=1 is counted as the number of times of selling included in history information. In an evaluation aggregate screen (aggregated result screen) shown in FIG. 13, the number of times of selling is I4 and the weighted average value is 4.6 (=65/14).

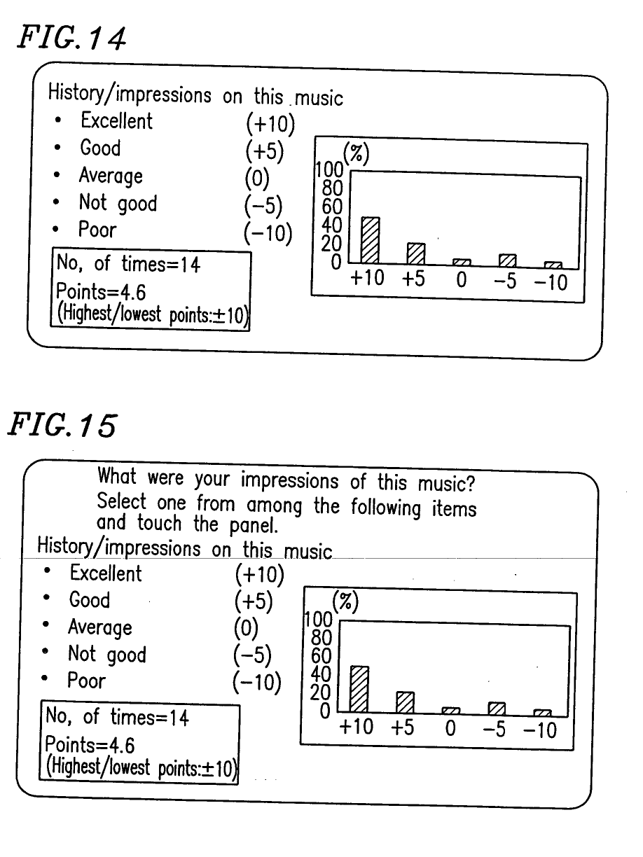

In the above description, as the display screen presented when electronic data is sold, the evaluation selection screen as shown in FIG. 12 is displayed on the display screen of the dedicated terminal apparatus. However, the present invention is not limited to this. As shown in FIG. 14 (in the case of a personal computer where a selection operation is performed by moving a cursor and clicking a mouse) and FIG. 15 (in the case of a dedicated terminal apparatus or the like where a selection operation is performed via a touch panel), in addition to the evaluation selection screen, aggregated results (see the evaluation aggregate screen shown in FIG. 13) and a graph showing frequency for each evaluation item (an evaluation status) may be displayed together in real time as the display screen presented when electronic data is sold. In such a case, the aggregated results and the graph may be displayed in real time as the evaluation selection is input.

When desired electronic data is transfer-purchased, as history information of the desired electronic data, in addition to the data of transfer-purchasing (the processing data), the number of times of transfer-purchasing can be included in the electronic data itself (the electronic data, history data, and money data are stored in a format). Information regarding evaluation aggregated when electronic data is sold (information regarding the numbers of times of selling and evaluation information) is displayed on a display screen on the side of the dedicated terminal apparatus or the user terminal apparatus (the personal computer), such that the user (purchaser) can refer to such information when purchasing electronic data.

As described above, in the case where information regarding aggregated evaluation, which can be displayed on a screen and is in a prescribed format, is registered together with electronic data in a storage section of the electronic data distribution server, when the electronic data is purchased, in addition to or apart from the evaluation selection screen, the evaluation aggregate screen including the aggregated results and the graph is displayed, as history information of the desired electronic data, on the display screen. The history evaluation information (the evaluation aggregate screen) is objective information and the purchaser can refer to such information for the evaluation status of the electronic data and can use it for determining whether or not to purchase the electronic data.

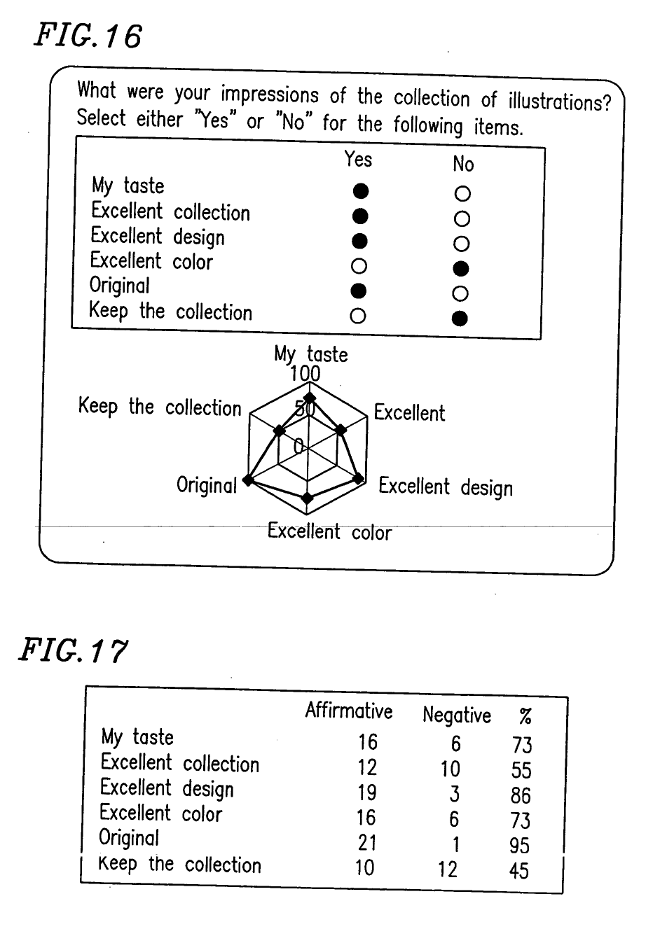

Next, another case is described. In the case where the user (the seller) evaluates, for example, “a collection of still images” such as illustrations (originally created by the seller) while checking them on, for example, the display screen of the user terminal apparatus, an evaluation selection screen (see, for example, FIG. 16) is displayed on the display screen of the user terminal apparatus (personal computer) during transferring (selling) of the electronic data. The user (the seller) moving a cursor on the evaluation screen so as to sequentially make selection with respect to each item, so that “◯” on each item is changed into “●”. History information regarding the selection is registered in the electronic data distribution server and is sequentially aggregated. The aggregated results are displayed in real time as a prescribed type of graph at, for example, the lower center of FIG. 16.

Specifically, in the case where selling of electronic data to the operator-side electronic data distribution server is performed, for example, twenty-two times, the results are given based on the number of affirmatives answers (Yes) and shown as the case (the evaluation aggregate screen) of FIG. 17. If the user evaluates electronic data at the time of selling thereof, the presence of the sixth evaluation item in FIG. 17, “Keep the collection”, is contradictory. However, if the evaluation is extended to the time of original purchase, the presence of the sixth evaluation item is not put in question. In this case, the purchaser can check the evaluation status of electronic data and can use it for determining whether or not to purchase the electronic data.

According to Embodiment 6, the amount of copyright fee paid to the copyright owner depends on an evaluation status (the number of times of selling and evaluation information) and the number of times of purchasing. Accordingly, as the number of pieces of electronic data to be put on the market (the number of times of selling and purchasing) is increased, the copyright fee paid to the copyright owner is increased and the initial copyright fee paid to the copyright owner can be reduced, so that the purchase price for the electronic data is reduced correspondingly. This is advantageous to general users (purchasers) and introduces the market mechanism that sales of electronic data are further increased. When a specific type of electronic data sells well, the aggregated amount of copyright fee is increased depending on the number of times of selling and purchasing of the specific type of electronic data. Therefore, copyright owners intend to create electronic data that sells well. This achieves an effect of greatly accelerating the spread of the electronic data transaction.

Embodiment 6 is described with respect to a configuration in which history information (including evaluation aggregate information) having a prescribed format is used so as to be stored together with electronic data. However, the present invention is not limited to such configuration. Electronic data and history information can be registered so as to be linked to each other. When specific electronic data is purchased, history information linked to the specific electronic data is searched and extracted such that the extracted history information is displayed on the screen. The history information screen allows the seller who sees that screen to select and input evaluations at the time of selling and allows the purchaser who sees that screen to take good advantage of the information when making a decision to purchase electronic data.

As described above, according to Embodiments 1, 2, and 5, in the case where copyright-protected electronic data is intangible data distributed through a network or by a satellite, when the holder (the consumer) who obtained such electronic data at a regular price through a prescribed route to purchasing determines that the electronic data is not necessary, the holder can onerously deliver over the electronic data to the input/output dedicated system 2 or 4. The operator who manages the input/output dedicated system 2 or 4 can build a secondhand selling system in which the same input/output dedicated system 2 or 4 can be used for secondhand selling of the electronic data, which is onerously delivered over to other consumer, at a price lower than the regular price. Specifically, based on the market awareness that the purchase price for aged electronic data used for a certain period of time is required to be low, the electronic data transaction systems 1, 3, 11, and 31 can be built as a new business model which expands the electronic data transaction market.

Further, in the business model where a portion of an alternative value is returned to the copyright owner each time electronic data is transferred, purchasing, selling, and reselling (secondhand selling) of electronic data are promoted, and besides, copyright is granted each time purchasing, selling, and secondhand selling of electronic data are promoted, so that an alternative value is also returned to the copyright owner. Accordingly, returns to the copyright owner are increased as frequencies of purchasing, selling, and secondhand selling of electronic data are increased and the market value of the electronic data is increased. This makes it possible to build a business model based on the market competition mechanism, thereby achieving advantageous electronic data transaction systems 1, 3, 11, or 31 which possibly reduces the price for electronic data.

In Embodiments 1, 2 and 5, means for distributing desired music content is constructed by a network using optical fibers or the Internet. However, the present invention is not limited to this, and a system where desired music content is distributed to a dedicated terminal apparatus including a hard disc by a satellite or a system where a network is not built and the dedicated terminal apparatus is a jukebox using optical discs (in the form of ROMs) may be employed.

Further, in Embodiments 1, 2, and 5, a recording medium used by the purchaser or seller (or the reseller) is a semiconductor memory or a hard disc. However, the present invention is not limited to this, and a MiniDisc (MD) or an optical recording disc of other type may be used. Furthermore, in Embodiments 1-6, electronic data is described as music content or the like. However, the present invention is not limited to this, and any types of electronic data as represented by software for use in personal computers may be used. In particular, in the case of recording music contents to an MD, an “ATRAC” method is used for encoding contents and in the case of recording music contents to a semiconductor memory, an audio encoding method, such as an “MP3” method, is used. Variations can be made by employing various cases of combinations other than those described above.

Further still, in Embodiments 1, 2, and 5, as described above, means for protecting copyright (processing according to Embodiment 4), such as a method for performing mutual authentication with the personal computer 41 and a method for enciphering music contents, is employed.

Further still, transferring of data to/from the hard disc 411 of the personal computer 41 is described in Embodiment 2. However, the present invention is not limited to this, and a recording medium removable from the personal computer 41 may be used for transferring data thereto/therefrom instead of using the hard disc 411.

In the case where a portion of the first alternative value is paid from the operator to the reseller when data is transfer-purchased, there are a variety of types of possible payment methods. For example, an alternative value is aggregated for each type of items at the server side, and payment to the operator, copyright owners, purchasers, and sellers (including resellers) can be separately conducted based on the aggregated results. Alternatively, home banking or Net banking is configured by linking the operator, copyright owners, purchasers, and sellers to a bank, such that credit processing is conducted by inputting of ID so that withdrawing from or depositing to the bank is performed, and thus any charge can be paid automatically.

The above-described effects of the present invention are summarized as the following points (1) through (10).

(1) In the case where copyright-protected electronic data is distributed from an input/output dedicated system via a network, when the holder who obtained the electronic data at the regular price through the legitimate route for purchasing determines that such electronic data is not necessary, the holder can onerously deliver over the electronic data by transferring the electronic data desired to be sold to the input/output dedicated system via a dedicated terminal apparatus installed in, for example, a convenience store or via an exclusive prescribed user terminal apparatus, such as a personal computer. This reselling system accelerates the spread of electronic data transaction.

(2) In the case where copyright-protected electronic data is distributed via a network, when the holder who is a consumer and obtained the electronic data at the regular price through the legitimate route for purchasing determines that such electronic data is not necessary, the holder can onerously deliver over the electronic data by transferring the electronic data desired to be sold to an input/output dedicated system via a dedicated terminal apparatus installed in, for example, a convenience store or via an exclusive prescribed user terminal apparatus, such as a personal computer. The operator who manages the input/output dedicated system uses the same input/output dedicated system to build a secondhand selling system for selling the electronic data, which is onerously delivered over, at second hand to another consumer at a price lower than the regular price. In this manner, by adding the secondhand selling system to the selling system, it is possible to further accelerate the spread of the electronic data transaction. Accordingly, based on the market awareness that the purchase price for aged electronic data used for a certain period of time is required to be low, it is possible to build a method for performing electronic data transaction as a new business model which expands the electronic data transaction market.

(3) The operator manages the input/output dedicated system as a prescribed route for purchasing the second electronic data, which is directly obtained from the copyright owner and on which electronic data transaction has never been performed, whereby the purchaser can transfer-purchase the second electronic data from the input/output dedicated system via the dedicated terminal apparatus or the exclusive prescribed user terminal apparatus without leaving a duplicate of the second electronic data and the operator can receive from the purchaser the third alternative value involved in the transfer-purchasing of the electronic data. This allows the electronic data transaction not only to resell and secondhand sell electronic data but also to function as the prescribed legitimate route for purchasing.

(4) In addition to the data transfer-reselling described above, transfer-selling of electronic data on which electronic data transaction has never been performed is possible as a method of transfer-selling data, and thus consumers' eagerness for performing electronic data transaction is intensified, thereby further accelerating the spread of the electronic data transaction.

(5) Electronic data is recorded in an exclusive prescribed recording medium without allowing the holder to have a duplicate of the electronic data and the holder loads the recording medium into a dedicated terminal apparatus or a user terminal apparatus so as to transfer-resell electronic data to the input/output dedicated system. Further, the purchaser loads an exclusive prescribed recording medium into a dedicated terminal apparatus or a user terminal apparatus so as to transfer-purchase electronic data from the input/output dedicated system without leaving a duplicate of the electronic data. Furthermore, the electronic data is recorded to the exclusive prescribed recording medium, and therefore a consumer who is the holder or the purchaser is not required to have a user terminal apparatus and can easily provide and receive electronic data by simply going to a place where the dedicated terminal apparatus is installed.

(6) A portion of at least one of alternative values generated by transferring of electronic data is provided to the copyright owner of the electronic data, and therefore it is possible to build a business model where a portion of an alternative value is returned to the copyright owner each time electronic data is transferred. This allows not only the acceleration of reselling and secondhand selling of electronic data but also an increase of returns to the copyright owner of electronic data as the frequency of secondhand selling of the electronic data is increased and the market value is increased. Accordingly, a business model based on the market competition mechanism can be built, returns to the copyright owner when electronic data is initially purchased through the legitimate route can be small as compared to the case where the electronic data is provided in the tangible form (e.g., in the form of a reproduction-only optical disc (the ROM form)). From the viewpoint of consumers (purchasers), it is possible to obtain an electronic data transaction method which possibly reduces the price of electronic data.

(7) A display function is provided for displaying at least one of listings of alternative values for each piece of electronic data, and therefore a consumer who is the holder or the purchaser can consentingly conduct electronic data transaction by using the display function in order to refer to the listings of alternative values for electronic data.

(8) Information regarding the number of times of transfer-selling and electronic data evaluation information based on inputs from a seller are recorded when electronic data is transfer-sold and an electronic data evaluation screen based on the number-of-times information and the evaluation information is displayed when the electronic data is transfer-purchased. Therefore, when transfer-purchasing the electronic data, the purchaser can refer to the evaluation screen so as to be ensured to obtain popular electronic data, thereby greatly accelerating the spread of the electronic data transaction. Further, the amount of copyright fee of electronic data which is paid into the copyright owner's account depends on the number of times of purchasing which is the number-of-times information regarding data transfer-purchasing. Accordingly, as the number of pieces of electronic data to be put on the market is increased, the copyright fee paid to the copyright owner is increased and the initial copyright fee paid to the copyright owner can be reduced, so that the purchase price for the electronic data is reduced correspondingly. This is advantageous to general users (purchasers) and introduces the market mechanism that sales of electronic data are further increased. When a specific type of electronic data sells well, the aggregated amount of copyright fee is increased depending on the number of times of selling and purchasing of the specific type of electronic data. Therefore, copyright owners intend to create electronic data that sells well. This achieves an effect of greatly accelerating the spread of the electronic data transaction.

(9) Values for all kinds of electronic data to be commercially transacted can be directly determined or processed in terms of currency.

(10) An electronic data transaction system according to the present invention can be used with the above-described electronic data transaction method of the present invention in the most suitable manner.

### INDUSTRIAL APPLICABILITY

In the field of computer technologies for electronic data transaction in which copyright-protected electronic data is transacted, the spread of the electronic data transaction can be further accelerated.

1. An electronic data transaction method for performing electronic data transaction using an operator-side input/output dedicated system in which a plurality of dedicated terminal apparatuses capable of inputting/outputting copyright-protected electronic data thereto/therefrom are networked, the method characterized in that first electronic data is transfer-sold to the input/output dedicated system via a dedicated terminal apparatus without allowing the first electronic data to be duplicated and a portion of a first alternative value involved in the data transfer-selling is paid from the operator to the seller.

2. An electronic data transaction method for performing electronic data transaction using an operator-side input/output dedicated system in which a plurality of dedicated terminal apparatuses capable of inputting/outputting copyright-protected electronic data thereto/therefrom are networked, the method characterized in that:
first electronic data is transfer-sold to the input/output dedicated system via/from a dedicated terminal apparatus without allowing the first electronic data to be duplicated and a portion of a first alternative value involved in the data transfer-selling is paid from the operator to the seller; and
the first electronic data is transfer-purchased from the input/output dedicated system via/to the dedicated terminal apparatus without leaving a duplicate of the first electronic data and a second alternative value involved in the data transfer-purchasing is paid from the purchaser to the operator.

3. An electronic data transaction method according to claim 2, characterized in that second electronic data on which electronic data transaction has never been performed is transfer-purchased via the dedicated terminal apparatus without leaving a duplicate of the second electronic data and a third alternative value involved in the data transfer-purchasing is paid from the purchaser to the operator.

4. An electronic data transaction method for performing electronic data transaction using an operator-side input/output dedicated system connected via a network to a plurality of user terminal apparatuses capable of inputting/outputting copyright-protected electronic data thereto/therefrom, the method characterized in that first electronic data is transfer-sold to the input/output dedicated system via a user terminal apparatus without allowing the first electronic data to be duplicated and a portion of a first alternative value involved in the data transfer-selling is paid from the operator to the seller.

5. An electronic data transaction method for performing electronic data transaction using an operator-side input/output dedicated system connected via a network to a plurality of user terminal apparatuses capable of inputting/outputting copyright-protected electronic data thereto/therefrom, the method characterized in that:
first electronic data is transfer-sold to the input/output dedicated system via/from a user terminal apparatus without allowing the first electronic data to be duplicated and a portion of a first alternative value involved in the data transfer-selling is paid from the operator to the seller; and
the first electronic data is transfer-purchased from the input/output dedicated system via/to the user terminal apparatus without leaving a duplicate of the first electronic data and a second alternative value involved in the data transfer-purchasing is paid from the purchaser to the operator.

6. An electronic data transaction method according to claim 5, characterized in that second electronic data on which electronic data transaction has never been performed is transfer-purchased via the user terminal apparatus without leaving a duplicate of the second electronic data and a third alternative value involved in the data transfer-purchasing is paid from the purchaser to the operator.

7. An electronic data transaction method according to claim 1 or 4, characterized in that the data transfer-selling is at least either data transfer-reselling or data transfer-selling of electronic data on which electronic data transaction has never been performed.

8. An electronic data transaction method according to claim 1 or 4, characterized in that: the electronic data can be transferred to an exclusive prescribed recording medium without allowing the electronic data to be duplicated; and the recording medium is loaded into the dedicated terminal apparatus or the user terminal apparatus so as to allow the electronic data to be transfer-sold from the recording medium to the input/output dedicated system via the dedicated terminal apparatus or the user terminal apparatus and so as to allow the electronic data to be transfer-purchased from the input/output dedicated system to the recording medium via the dedicated terminal apparatus or the user terminal apparatus without leaving a duplicate of the electronic data.

9. An electronic data transaction method according to claim 3 or 6, characterized in that a portion of at least any one of the first through third alternative values is paid from the operator to a copyright owner of the electronic data.

10. An electronic data transaction method according to claim 3 or 6, characterized by configuring a terminal apparatus in the input/output dedicated system so as to display at least any one of a listing of the first alternative value for the first electronic data, a listing of the second alternative value for the first electronic data, and a listing of the third alternative value for the second electronic data.

11. An electronic data transaction method according to claim 3 or 6, characterized in that: information regarding the number of times of at least transfer-selling of electronic data selected from the group consisting of the transfer-selling of electronic data and transfer-purchasing of electronic data is recorded in a prescribed storage section; evaluation information about the electronic data based on input from the seller is recorded in the prescribed storage section when the electronic data is transfer-sold; and an electronic data evaluation aggregate screen based on the number-of-times information the evaluation information is displayed when the electronic data is transfer-purchased.

12. An electronic data transaction method according to claim 3 or 6, characterized in that at least any one of the first alternative value, the second alternative value, and the third alternative value corresponds to a charge settling amount.

13. A program wherein an electronic data sell-transferring step for allowing a computer to execute a data transfer operation for transferring desired copyright-protected electronic data via a terminal apparatus from the seller's memory means to an input/output dedicated system connected to the terminal apparatus via a network is recorded in a readable recording medium.

14. A program according to claim 13, wherein a charge settling step for allowing a computer to execute an operation for processing charge settlement in accordance with electronic data transfer-sell processing and with reference to a prescribed charge table is recorded in the readable recording medium.

15. An electronic data transaction system for performing transaction of copyright-protected electronic data, characterized by comprising: electronic data transfer-purchase processing means for performing electronic data transfer-purchase processing via a terminal apparatus so as to transfer-purchase desired electronic data from an operator-side storage section to a purchaser-side storage section via a network; and electronic data transfer-sell processing means for performing electronic data transfer-sell processing via the terminal apparatus so as to transfer-sell electronic data desired to be sold from a seller-side storage section to the operator-side storage section via the network.

16. An electronic data transaction system according to claim 15, characterized by comprising charge settling means for performing charge settle processing so as to settle charges responsive to the electronic data transfer-purchase processing and the electronic data transfer-sell processing.
